(19) United States
(12) Patent Application Publication
(10) Pub. No.: US 2022/0343134 A1
(43) Pub. Date: Oct. 27, 2022

(54) CONVOLUTIONAL NEURAL NETWORK ARCHITECTURES BASED ON SYNAPTIC CONNECTIVITY

(71) Applicant: X Development LLC, Mountain View, CA (US)

(72) Inventors: Bangyan Chu, Fairfax, VA (US); Sarah Ann Laszlo, Mountain View, CA (US); Michael Jeremiah Crosse, Bronx, NY (US)

(21) Appl. No.: 17/236,647

(22) Filed: Apr. 21, 2021

(51) Int. Cl. G06N 3/00; G06N 3/04; G06N 3/08

(52) U.S. Cl. CPC G06N 3/008; G06N 3/04; G06N 3/08

(57) ABSTRACT

Methods, systems, and apparatus, including computer programs encoded on a computer storage medium, for generating and executing biological convolutional neural network layers. One of the methods obtaining a network input; and processing the network input using a neural network to generate a network output, wherein the neural network is configured to perform operations comprising: generating a layer input to a convolutional neural network layer based on the network input; and generating a layer output of the convolutional neural network layer based on the layer input, comprising applying a convolutional kernel to the layer input, wherein the convolutional kernel corresponds to a specified neuron in a brain of a biological organism and values of parameters of the convolutional kernel are based on synaptic connectivity between the specified neuron and each of a plurality of other neurons in the brain of the biological organism.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of computational units to generate an output for a received input. For example, a deep neural network is a deep machine learning model that includes an output layer and one or more hidden layers that each apply a non-linear transformation to a received input to generate an output.

### SUMMARY

This specification describes systems implemented as computer programs on one or more computers in one or more locations for implementing convolutional neural network layers whose convolutional kernels have been determined according to the synaptic connectivity between neurons in the brain of a biological organism, e.g., a fly. This specification also describes systems for training a neural network that includes one or more such convolutional neural network layers.

In this specification, a convolutional neural network layer of an artificial neural network whose convolutional kernel has been determined using the synaptic connectivity between neurons in the brain of a biological organism is called a “biological convolutional neural network layer.” That is, the biological convolutional neural network layer is an artificial neural network layer (i.e., the biological convolutional neural network layer is computer-implemented), but its convolutional kernel has been determined using the synaptic connectivity in the brain of a biological organism. In this specification, an artificial neural network that includes at least one biological convolutional neural network layer is called a “biological convolutional neural network.” Identifying a convolutional neural network as a “biological” convolutional neural network is intended only to conveniently distinguish such neural networks from other convolutional neural networks (e.g., convolutional neural networks whose convolutional kernels have been machine learned or randomly generated), and should not be interpreted as limiting the nature of the operations that can be performed by the biological convolutional neural network or otherwise implicitly characterizing the biological convolutional neural network.

The convolutional kernels of a biological convolutional neural network layer can be determined using a synaptic connectivity graph. A synaptic connectivity graph refers to a graph representing the structure of synaptic connections between the neurons in the brain of a biological organism. For example, the synaptic connectivity graph can be generated by processing a synaptic resolution image of the brain of a biological organism.

Particular embodiments of the subject matter described in this specification can be implemented so as to realize one or more of the following advantages.

The systems described in this specification can train and implement a biological convolutional neural network. As described in this specification, biological convolutional neural networks can achieve a higher performance (e.g., in terms of prediction accuracy), than other neural networks of an equivalent size (e.g., in terms of number of parameters). Put another way, biological convolutional neural networks that have a relatively small size (e.g., 100 parameters) can achieve comparable performance with other neural networks that are much larger (e.g., thousands or millions of parameters). Therefore, using techniques described in this specification, a system can implement a highly efficient, low-latency, and low-power-consuming convolutional neural network. That is a system that implements a biological convolutional neural network can reduce the use of computational resources, e.g., memory and computational power, relative to systems that implement other neural networks. These efficiency gains can be especially important in low-resource or low-memory environments, e.g., on mobile devices or other edge devices. Additionally, these efficiency gains can be especially important in situations in which the biological convolutional neural network is continuously processing network inputs, e.g., in an application that continuously processes input audio data to determine whether a “wakeup” phrase has been spoken by a user.

Generally, convolutional neural network layers have fewer parameters than fully-connected neural network layers, and thus can be more efficiently trained. That is, compared to fully-connected layers that receive a layer input of the same size, a convolutional neural network layer can have significantly fewer parameters, further improving the efficiency of the neural network. A biological convolutional neural network layer can further improve on the efficiency of convolutional layers by leveraging the information that is embedded in a synaptic connectivity graph that characterizes the brain of the biological organism. The synaptic connectivity graph can encode information from the brain of the biological organism, which has been adapted through evolutionary pressures for accomplishing a wide variety of tasks. A biological convolutional neural network layer can generate rich intermediate representations of network inputs that can be used by downstream neural network layers to generate network outputs.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example biological convolutional neural network system.

FIG. 2 illustrates example convolutional kernels generated using synaptic connectivity.

FIG. 3 illustrates an example neural network computing system.

FIG. 4A and FIG. 4B illustrate example recurrent neural networks that include brain emulation convolutional subnetworks.

FIG. 5 illustrates an example of generating a biological convolutional neural network based on a synaptic resolution image of the brain of a biological organism.

FIG. 6 shows an example data flow for generating a synaptic connectivity graph and a brain emulation neural network based on the brain of a biological organism.

FIG. 7 shows an example kernel generation system.

FIG. 8 illustrates an example graph and an example sub-graph.

FIG. 9 is a flow diagram of an example process for implementing a biological convolutional neural network layer.

FIG. 10 is a flow diagram of an example process for generating a biological convolutional neural network.

FIG. 11 is a flow diagram of an example process for generating a convolutional kernel a sub-graph of a synaptic connectivity graph.

FIG. 12 is a block diagram of an example computer system.

Like reference numbers and designations in the various drawings indicate like elements.

### DETAILED DESCRIPTION

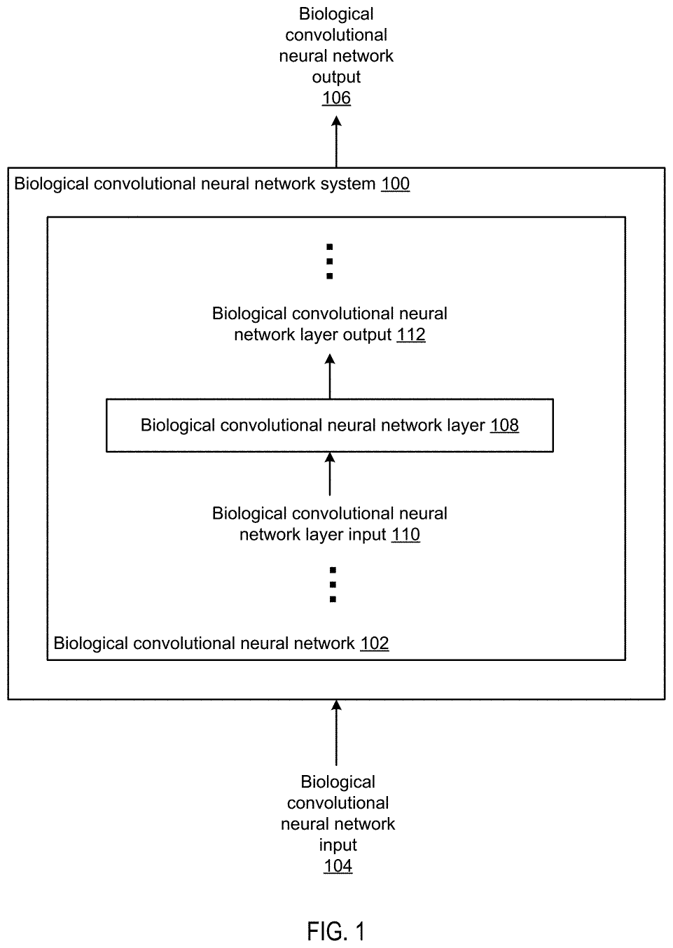

FIG. 1 shows an example biological convolutional neural network system 100. The biological convolutional neural network system 100 is an example of a system implemented as computer programs on one or more computers in one or more locations in which the systems, components, and techniques described below are implemented.

A convolutional neural network is a neural network that includes one or more convolutional neural networks layers. A convolutional neural network layer is a neural network layer that is configured to process a layer input using a convolutional kernel. A convolutional kernel of a convolutional neural network layer is an ordered collection of numeric values that can be convolved against the layer input to the convolutional neural network layer, which is larger than the convolutional kernel. For example, a one-dimensional convolutional kernel can be a vector of floating point or other numeric values, while a two-dimensional convolutional kernel can be a two-dimensional matrix of floating point or other numeric values. In other words, a convolutional neural network layer is configured to receive a layer input and convolve the convolutional kernel with the layer input to generate an alternative representation of the layer input. Optionally, the convolutional neural network layer can apply a non-linear activation function to the alternative representation to generate the layer output of the convolutional neural network layer.

The biological convolutional neural network system 100 includes a biological convolutional neural network 102. The biological convolutional neural network 102 includes one or more biological convolutional neural network layers (e.g., the biological convolutional neural network layer 108). Optionally, the biological convolutional neural network 102 can also include one or more of: one or more standard convolutional neural network layers, one or more feed-forward neural network layers, one or more recurrent neural network layers, or any other appropriate type of neural network layer.

The biological convolutional neural network 102 is configured to receive a biological convolutional neural network input 104 and to generate a biological convolutional neural network output 106 from the biological convolutional neural network input 104. The biological convolutional neural network input 104 can be any kind of digital data input, and the biological convolutional neural network output 106 can be any kind of score, classification, or regression output based on the input.

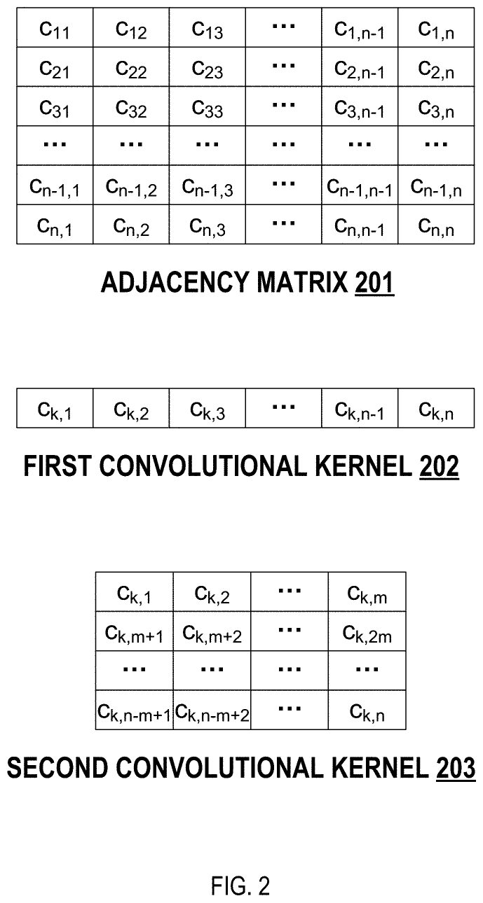

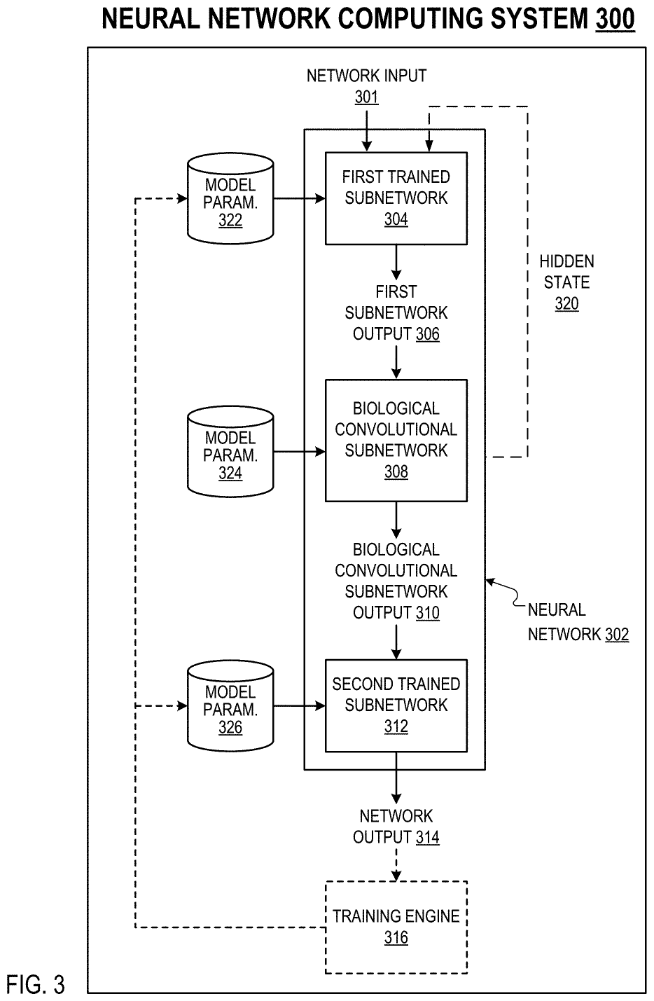

As will be described in more detail below with reference to FIG. 2 and FIG. 3, the biological convolutional neural network layer 108 is configured to receive a biological convolutional layer input 110, and to process the biological convolutional neural network layer input 110 using a convolutional kernel that has been generated using the synaptic connectivity between neurons in the brain of a biological organism, generating a biological convolutional neural network layer output 112. In general, the biological convolutional layer input 110 may be the biological convolutional network input 104 (i.e., if the biological convolutional neural network layer 108 is the first layer in the biological convolutional neural network 102) or the output of another layer of the biological convolutional neural network 102. The biological convolutional neural network layer input 110 and the biological convolutional neural network layer output 112 may be represented in any appropriate numerical format, for example, as vectors or as matrices.

An example biological convolutional neural network is discussed in more detail below with reference to FIG. 3.

FIG. 2 illustrates example convolutional kernels 202 and 203 generated using synaptic connectivity in the brain of a biological organism.

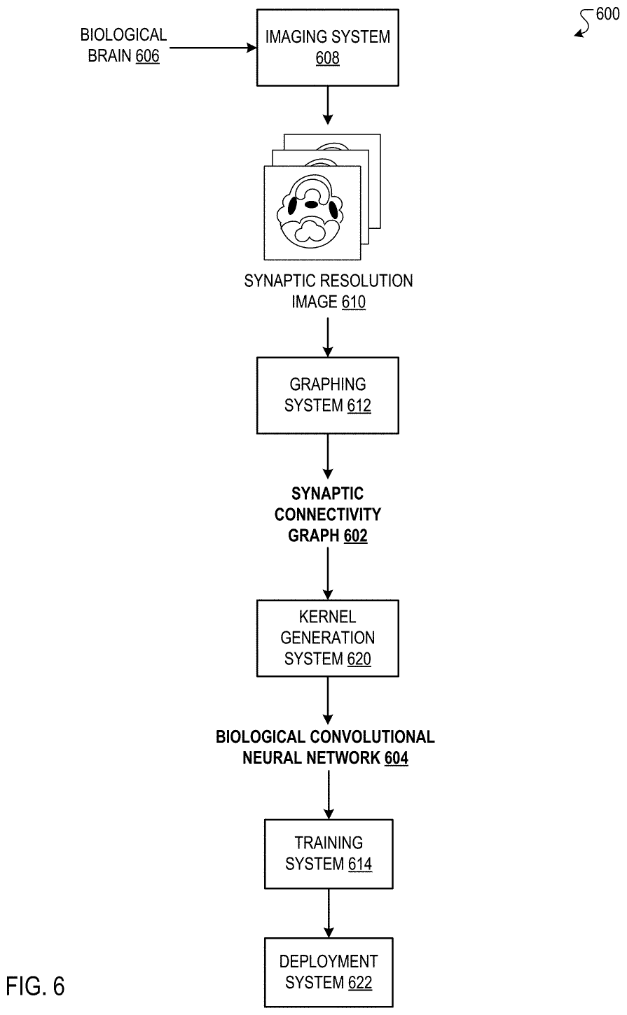

As described in more detail below with reference to FIG. 6, a system (e.g., the graphing system 612 depicted in FIG. 6), can generate a synaptic connectivity graph that represents the synaptic connectivity between neurons in the brain of the biological organism. The synaptic connectivity graph can be represented using an adjacency matrix 201.

The adjacency matrix 201 includes n² elements, where n is the number of neurons drawn from the brain of the biological organism. For example, the adjacency matrix 201 can include hundreds, thousands, tens of thousands, hundreds of thousands, millions, tens of millions, or hundreds of millions of elements.

Each element of the adjacency matrix 201 represents the synaptic connectivity between a respective pair of neurons in the set of n neurons. That is, each element c_{i,j} identifies the synaptic connection between neuron i and neuron j. As described in more detail below, in some implementations, each of the elements c_{i,j} are either zero (representing that there is no synaptic connection between the corresponding neurons) or one (representing that there is a synaptic connection between the corresponding neurons), while in some other implementations, each element c_{i,j} is a scalar value representing the strength of the synaptic connection between the corresponding neurons. In some implementations (e.g., in implementations in which the synaptic connectivity graph is undirected), the adjacency matrix 201 is symmetric (i.e., each element c_{i,j} is the same as element while in some other implementations (e.g., in implementations in which the synaptic connectivity graph is directed), the adjacency matrix 201 is not symmetric (i.e., there may exist elements c_{i,j} and c_{j,i} such that c_{i,j}≠c_{j,i}).

Although the above description refers to neurons in the brain of the biological organism, generally the elements of the adjacency matrix can correspond to pairs of any appropriate component of the brain of the biological organism. For example, each element can correspond to a pair of voxels in a voxel grid of the brain of the biological organism. As another example, each element can correspond to a pair of sub-neurons of the brain of the biological organism. As another example, each element can correspond to a pair of sets of multiple neurons of the brain of the biological organism.

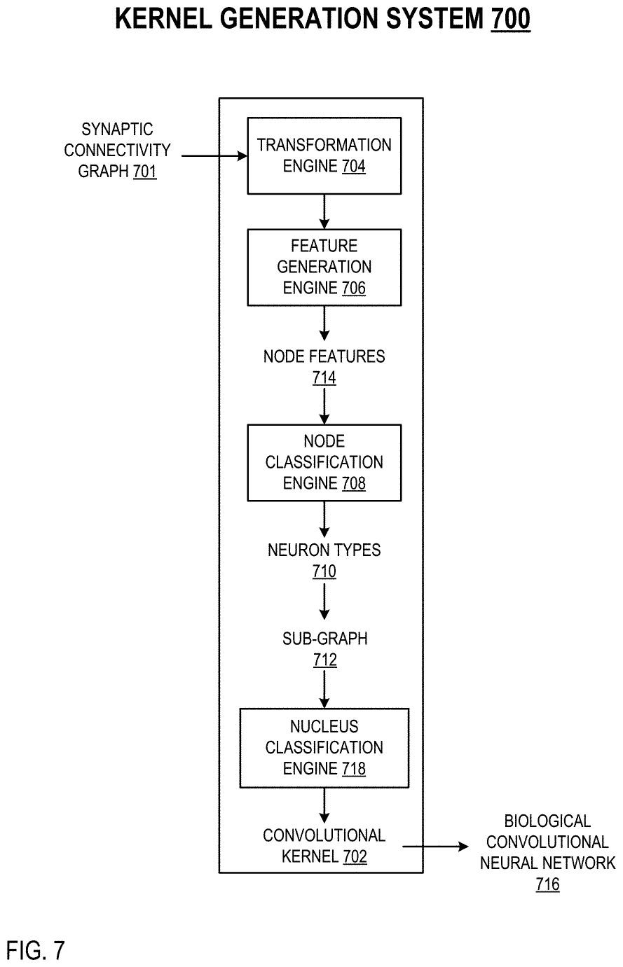

In some implementations, the adjacency matrix 201 represents the entire synaptic connectivity graph. That is, the adjacency matrix 201 can include a respective row and column for each node of the synaptic connectivity graph. In some other implementations, the adjacency matrix 201 represents a sub-graph of the synaptic connectivity graph. That is, the adjacency matrix 201 can include a respective row and column for each node of the sub-graph, and not any other node of the synaptic connectivity graph. For example, the adjacency matrix 201 can represent only neurons of a particular type in the brain of the biological organism. Identifying neurons of a particular type is discussed in more detail below with reference to FIG. 7.

The system can generate a convolutional kernel for a biological convolutional neural network layer (e.g., a convolutional kernel for one of the biological convolutional neural network layers of the biological convolutional subnetwork 308 depicted in FIG. 3) using any subset of the elements of the adjacency matrix 201.

In some implementations, the system can generate a one-dimensional kernel, which the biological convolutional neural network layer can convolve against a one-dimensional layer input.

For example, the system can generate a one-dimensional convolutional kernel from a single row of the adjacency matrix 201. As a particular example, the system can extract a row from the adjacency matrix and determine the row to be the first convolutional kernel 202. That is, the elements {c_{k,1}, . . . , c_{k,n}} of the first convolutional kernel 202 are equal to the elements of the k^{th} row of the adjacency matrix 201, which represents the synaptic connectivity between the k^{th} measured neuron in the brain of the biological organism and each other measured neuron in the brain of the biological organism. In implementations in which the synaptic connectivity graph is directed, the k^{th} row of the adjacency matrix 201 (and thus the first convolutional kernel 202) can represent the outgoing synaptic connectivity from the k^{th} measured neuron to the other measured neurons. As another particular example, the system can generate a convolutional kernel from a subset of the elements of a single row of the adjacency matrix 201, e.g., by generating the convolutional kernel from the first P elements of the k^{th} row {c_{k,1}, . . . , c_{k,p}}, or by generating the convolutional kernel from every second element of the k^{th} row {c_{k,2}, c_{k,4}, . . . , c_{k,2i}}.

As another example, the system can generate a one-dimensional kernel from a single column of the adjacency matrix 201, e.g., by determining the convolutional kernel to be equal to the entire columns, the first P elements of the column, every second element of the column, or any other appropriate permutation of elements from the column. In implementations in which the synaptic connectivity graph is directed, the k^{th} column of the adjacency matrix 201 can represent the incoming synaptic connectivity from each of the other measured neurons to the k^{th} measured neuron.

In some other implementations, the system can generate a two-dimensional kernel, which the biological convolutional neural network layer can convolve against a two-dimensional layer input.

For example, the system can generate the second convolutional kernel 203 by extracting a row from the adjacency matrix 201 and re-shaping the row to be two-dimensional. That is, the elements {c_{k,1}, . . . , c_{k,n}} of the second convolutional kernel 203 are equal to the elements of the k^{th} row of the adjacency matrix 201, and have been rearranged such that the first m elements are in the first row of the second convolutional kernel 203, the next m elements are in the second row of the second convolutional kernel 203, and so on. As a particular example, if m=\sqrt{n}, then the second convolutional kernel 203 would be square. The rearrangement depicted in FIG. 2 is exemplary only; in general, the system can rearrange the elements of the k^{th} row (or a subset of the elements of the k^{th} row) of the adjacency matrix 201 in any appropriate way to generate the second convolutional kernel 203.

As another example, the system can generate a two-dimensional kernel by extracting a column from the adjacency matrix 201 and re-shaping the column to be two-dimensional. As a particular example, the first m elements can be in the first column of the convolutional kernel, the next m elements can be in the second column of the convolutional kernel, and so on.

As another example, the system can determine a two-dimensional convolutional kernel to be equal to the adjacency matrix 201 itself.

In some other implementations, the system can generate a three-dimensional kernel, which the biological convolutional neural network layer can convolve against a three-dimensional layer input. For example, the system can generate multiple two-dimensional kernels, e.g., as described above with reference to the second convolutional kernel 203, and generate a three-dimensional kernel by stacking the multiple generated two-dimensional kernels. As a particular example, the system can generate three two-dimensional kernels, and the biological convolutional neural network layer can convolve each against a different channel of an RGB image.

Generally, a convolutional kernel generated from the adjacency matrix 201 can have any dimensionality.

The system can select one or more particular neurons in the brain of the biological organism (corresponding to respective rows or columns of the adjacency matrix 201) to generate a convolutional kernel. As described in more detail below with reference to FIG. 7, the system can identify a region of the brain that includes the one or more particular neurons and whose function is related to the machine learning task that the neural network is configured to do. The system can then extract the corresponding rows and/or columns of the adjacency matrix 201 corresponding to the one or more particular neurons and generate the convolutional kernel as described above.

In some implementations in which the biological convolutional neural network includes multiple biological convolutional neural network layers whose convolutional kernels have been generated using synaptic connectivity, the system can select a respective different neuron or set of neurons to generate each convolutional kernel.

In some such implementations, each selected neuron or set of neurons (corresponding to respective convolutional kernels) can be in the same region of the brain. For example, when generating the convolutional kernel for each biological convolutional neural network layer, the system can randomly select a new neuron or a new set of neurons from the region of the brain.

In some other such implementations, the selected neurons can form a “path” through the brain of the biological organism. That is, for each biological convolutional neural network layer in a sequence of biological convolutional neural network layers, the system can select a next neuron along the path through the brain of the biological organism to generate the convolutional kernel.

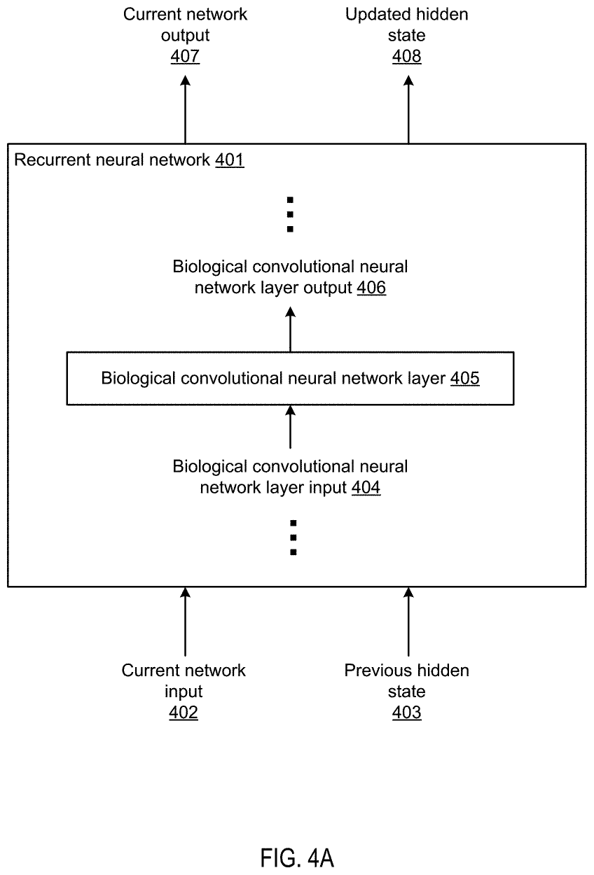

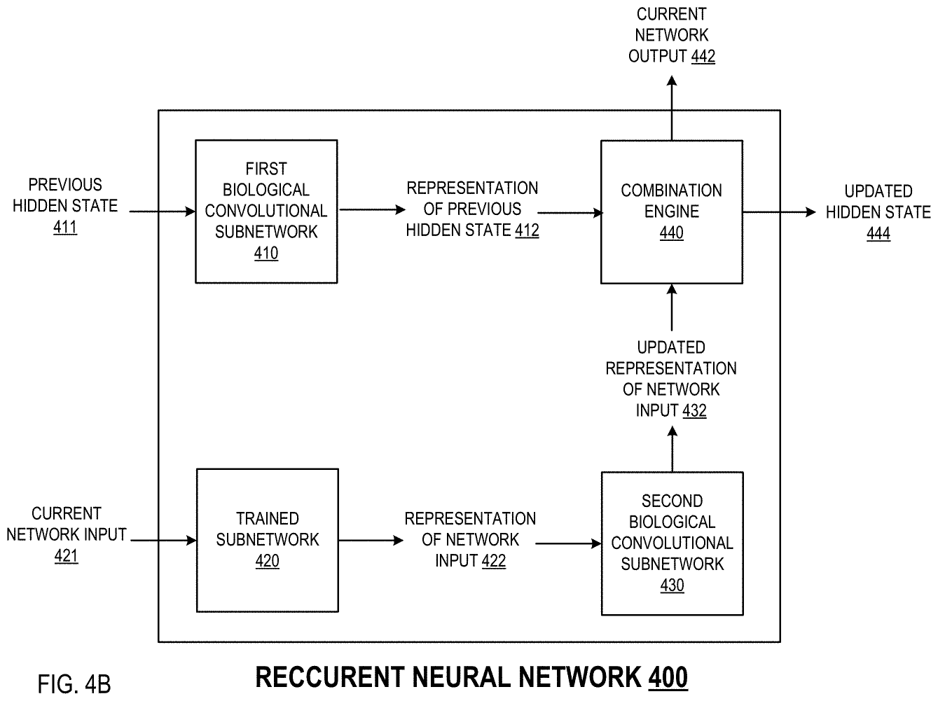

The path through the brain of the biological organism can be determined such that the path is biologically meaningful. For example, the system or a user can identify a path through the brain of the biological organism that is known to be a path that information of a particular type travels through the brain; thus, the biological convolutional neural network can simulate the processing of a network input of the particular type by processing the network input using the sequence of biological convolutional neural network layers, where each layer (corresponding to a respective neuron) passes its layer output to the next layer (corresponding to the next neuron in the path) in the sequence of layers. As a particular example, the path can go from the surface of the brain to the center of the brain. For instance, the first neuron in the path can be a neuron on the surface of the brain, the last neuron in the path can be a neuron in the center of the brain, and the path can simulate the input of an external stimulus to the brain of the biological organism (e.g., the input of a ocular input, an aural input, a tactile input, etc. This process is discussed in more detail below with reference to FIG. 4B.

In some implementations in which the biological convolutional neural network is a recurrent neural network (i.e., processes a network input over multiple time steps), the system can generate a respective different convolutional kernel for each time step of the recurrent neural network. That is, the biological convolutional neural network layer can process its layer input using a different convolutional kernel at each time step of the recurrence. This process is described in more detail below with reference to FIG. 4B.

Biological convolutional neural network layers can be a component of any neural network, e.g., a feedforward neural network, a recurrent neural network, a transformer neural network, etc. That is, generally one or more biological convolutional neural network layers can be added to any type of neural network architecture. For example, the neural network can be a convolutional neural network that includes both i) one or more biological convolutional neural network layers whose convolutional kernels have been generated using synaptic connectivity as described above, and ii) one or more standard convolutional neural network layers whose convolutional kernels have been machine-learned. For example, the machine-learned convolutional kernels can be trained by updating the kernel parameters using backpropagation and gradient descent, as described below with reference to FIG. 3.

FIG. 3 shows an example neural network computing system 300. The neural network computing system 300 is an example of a system implemented as computer programs on one or more computers in one or more locations in which the systems, components, and techniques described below are implemented.

The neural network computing system 300 includes a neural network 302 that has (at least) three subnetworks: (i) a first trained subnetwork 304 (ii) a biological convolutional subnetwork 308, and (iii) a second trained subnetwork 312. The neural network 302 is configured to process a network input 301 to generate a network output 314.

The first trained subnetwork 304 is configured to process the network input 301 in accordance with a set of model parameters 322 of the first trained subnetwork 304 to generate a first subnetwork output 306. The biological convolutional subnetwork 308 is configured to process the first subnetwork output 306 in accordance with a set of model parameters 324 of the biological convolutional subnetwork 308 to generate a biological convolutional subnetwork output 310. The second trained subnetwork 312 is configured to process the biological convolutional subnetwork output 310 in accordance with a set of model parameters 326 of the second trained subnetwork 312 to generate the network output 314.

The biological convolutional subnetwork includes one or more biological convolutional neural network layers whose respective convolutional kernels have been determined using a graph representing synaptic connectivity between neurons in the brain of a biological organism. For example, the biological convolutional subnetwork 308 can be configured similarly to the biological convolutional neural network 102 described above with reference to FIG. 1.

In particular, the model parameters 324 of the convolutional kernels of the biological convolutional neural network layers of the biological convolutional subnetwork 308 can be determined according to data characterizing the neurons in the brain of the biological organism. An example technique for determining a convolutional kernel using a synaptic connectivity graph are described below with respect to FIG. 6. In some implementations, the convolutional kernels of the biological convolutional subnetwork 308 can be specified by the synaptic connectivity between neurons of a particular type in the brain, e.g., neurons from the visual system or the olfactory system, as described in more detail below with reference to FIG. 7.

Although the neural network 302 depicted in FIG. 3 includes one trained subnetwork 304 before the biological convolutional subnetwork 308 and one trained subnetwork 312 after the biological convolutional subnetwork 308, in general the neural network 302 can include any number of trained subnetworks before and/or after the biological convolutional subnetwork 308. In some implementations, the first trained subnetwork 304 and/or the second trained subnetwork 312 can include only one or a few neural network layers (e.g., a single fully-connected layer) that processes the respective subnetwork input to generate the respective subnetwork output.

In implementations where there are zero trained subnetworks before the biological convolutional subnetwork 308, the biological convolutional subnetwork 308 can receive the network input 301 directly as input. In implementations where there are zero trained subnetworks after the biological convolutional subnetwork 308, the biological convolutional subnetwork output 310 can be the network output 314.

Although the neural network 302 depicted in FIG. 3 includes a single biological convolutional subnetwork 308, in general the neural network 302 can include multiple biological convolutional subnetwork 308. In some implementations, each biological convolutional subnetwork 308 has the same set of model parameters 324; in some other implementations, each biological convolutional subnetwork 308 has a different set of model parameters 324. In some implementations, each biological convolutional subnetwork 308 has the same network architecture; in some other implementations, each biological convolutional subnetwork 308 has a different network architecture.

In some implementations, the neural network 302 is a recurrent neural network. In these implementations, the network input 301 includes a sequence of input elements. The first trained subnetwork 304 can process, at each of multiple time steps corresponding to respective input elements in the sequence, the input element to generate a respective first subnetwork output 306. At each time step, the biological convolutional subnetwork 308 can process the first subnetwork output 306 to generate a respective biological convolutional subnetwork output 310. At each time step, the second trained subnetwork 312 can process the biological convolutional subnetwork output 310 to generate an output element corresponding to the input element.

At each time step, the neural network 302 can maintain a hidden state 320. That is, at each time step, the neural network 302 updates its hidden state 320; then, at the subsequent time step in the sequence of time steps, the neural network 302 receives as input (i) the input element of the network input 301 corresponding to the subsequent time step and (ii) the current hidden state 320.

In some implementations in which the neural network 302 is a recurrent neural network (e.g., in the example depicted in FIG. 3), the first trained subnetwork 304 receives both i) the input element of the sequence of the network input 301 and ii) the hidden state 320. For example, the recurrent neural network 302 can combine the input element and the hidden state 320 (e.g., through concatenation, addition, multiplication, or an exponential function) to generate a combined input, and then process the combined input using the first trained subnetwork 304.

In some implementations in which the neural network 302 is a recurrent neural network, the biological convolutional subnetwork 308 receives as input the hidden state 320 and the first subnetwork output 306. For example, the neural network 302 can combine the first subnetwork output 306 and the hidden state 320 (e.g., through concatenation, addition, multiplication, or an exponential function) to generate a combined input, and then process the combined input using the biological convolutional subnetwork 308.

In some implementations in which the neural network 302 is a recurrent neural network, the second trained subnetwork 312 receives as input the hidden state 320 and the biological convolutional subnetwork output 310. For example, the neural network 302 can combine the biological convolutional subnetwork output 310 and the hidden state 320 (e.g., through concatenation, addition, multiplication, or an exponential function) to generate a combined input, and then process the combined input using the second trained subnetwork 312.

In some implementations in which the neural network 302 is a recurrent neural network, the updated hidden state 320 generated at a time step is the same as the output element generated at the time step. In some other implementations, the hidden state 320 is an intermediate output of the neural network 302. An intermediate output refers to an output generated by a hidden artificial neuron or a hidden neural network layer of the neural network 302, i.e., an artificial neuron or neural network layer that is not included in the input layer or the output layer of the neural network 302. For example, the hidden state 320 can be the biological convolutional subnetwork output 310. In some other implementations, the hidden state 320 is a combination of the output element and one or more intermediate outputs of the neural network 302. For example, the hidden state 320 can be computed using the output element and the biological convolutional subnetwork output 310, e.g., by combining the two outputs and applying an activation function.

In some implementations in which the neural network 302 is a recurrent neural network, after each input element in the network input 301 has been processed by the recurrent neural network 302 to generate respective output elements, the recurrent neural network 302 can generate a network output 314 corresponding to the network input 301. In some such implementations, the network output 314 is the sequence of generated outputs elements. In some other implementations, the network output 314 is a subset of the generated output elements, e.g., the final output element corresponding to the final input element in the sequence of input elements of the network input 301. In some other implementations, the recurrent neural network 302 further processes the sequence of generated output elements to generate the network output 314. For example, the network output 314 can be the mean of the generated output elements.

In some implementations, the biological convolutional subnetwork 308 itself has a recurrent neural network architecture. That is, the biological convolutional subnetwork 308 can process the first subnetwork output 306 multiple times at respective sub-time steps (referred to as sub-time steps to differentiate from the time steps of the neural network 302 in implementations where the neural network 302 is a recurrent neural network).

For example, the architecture of the biological convolutional subnetwork 308 can include a sequence of components (e.g., biological convolutional neural network layers or groups of biological convolutional neural network layers) such that the architecture includes a connection from each component in the sequence to the next component, and the first and last components of the sequence are identical. In one example, two biological convolutional neural network layers that are each directly connected to one another (i.e., where the first layer provides its output the second layer, and the second layer provides its output to the first layer) would form a recurrent loop. A recurrent biological convolutional subnetwork 308 can process the first subnetwork output 306 over multiple sub-time steps to generate a respective biological convolutional subnetwork output 310 at each sub-time step. In particular, at each sub-time step, the biological convolutional subnetwork 308 can process: (i) the first subnetwork output 306 (or a component of the first subnetwork output 306), and (ii) any outputs generated by the biological convolutional subnetwork 308 at the preceding sub-time step, to generate the biological convolutional subnetwork output 310 for the sub-time step. The neural network 302 can provide the biological convolutional subnetwork output 310 generated by the biological convolutional subnetwork 308 at the final sub-time step as the input to the second trained subnetwork 312. The number of sub-time steps over which the biological convolutional subnetwork 308 processes a network input can be a predetermined hyper-parameter of the neural network computing system 300.

In some implementations, in addition to processing the biological convolutional subnetwork output 310 generated by the output layer of the biological convolutional subnetwork 308, the second trained subnetwork 312 can additionally process one or more intermediate outputs of the biological convolutional subnetwork 308.

The neural network computing system 300 includes a training engine 316 that is configured to train the neural network 302.

The model parameters 324 for the biological convolutional subnetwork 308 are untrained. Instead, the model parameters 324 of the biological convolutional subnetwork 308 can be determined before the training of the trained subnetworks 304 and 312 based on the weight values of the edges in the synaptic connectivity graph. Optionally, the weight values of the edges in the synaptic connectivity graph can be transformed (e.g., by additive random noise) prior to being used for specifying model parameters 324 of the biological convolutional subnetwork 308. This procedure enables the neural network 302 to take advantage of the information from the synaptic connectivity graph encoded into the biological convolutional subnetwork 308 in performing prediction tasks.

Therefore, rather than training the entire neural network 302 from end-to-end, the training engine 316 can train only the model parameters 322 of the first trained subnetwork 304 and the model parameters 326 of the second trained subnetwork 312, while leaving the model parameters 324 of the biological convolutional subnetwork 308 fixed during training.

The training engine 316 can train the neural network 302 on a set of training data over multiple training iterations. The training data can include a set of training examples, where each training example specifies: (i) a training network input, and (ii) a target network output that should be generated by the neural network 302 by processing the training network input.

At each training iteration, the training engine 316 can sample a batch of training examples from the training data, and process the training inputs specified by the training examples using the neural network 302 to generate corresponding network outputs 314. In particular, for each training input, the neural network 302 processes the training input using the current model parameter values 322 of the first trained subnetwork 304 to generate a first subnetwork output 306. The neural network 302 processes the first subnetwork output 306 in accordance with the static model parameter values 324 of the biological convolutional subnetwork 308 to generate a biological convolutional subnetwork output 310. The neural network 302 then processes the biological convolutional subnetwork output 310 using the current model parameter values 326 of the second trained subnetwork 312 to generate the network output 314 corresponding to the training input.

The training engine 316 adjusts the model parameters values 322 of the first trained subnetwork 304 and the model parameter values 326 of the second trained subnetwork 312 to optimize an objective function that measures a similarity between: (i) the network outputs 314 generated by the neural network 302, and (ii) the target network outputs specified by the training examples. The objective function can be, e.g., a cross-entropy objective function, a squared-error objective function, or any other appropriate objective function.

To optimize the objective function, the training engine 316 can determine gradients of the objective function with respect to the model parameters 322 of the first trained subnetwork 304 and the model parameters 326 of the second trained subnetwork 312, e.g., using backpropagation techniques. The training engine 316 can then use the gradients to adjust the model parameter values 322 and 326, e.g., using any appropriate gradient descent optimization technique, e.g., an RMSprop or Adam gradient descent optimization technique.

The training engine 316 can use any of a variety of regularization techniques during training of the neural network 302. For example, the training engine 316 can use a dropout regularization technique, such that certain artificial neurons of the neural network 302 are “dropped out” (e.g., by having their output set to zero) with a non-zero probability p>0 each time the neural network 302 processes a network input. Using the dropout regularization technique can improve the performance of the trained neural network 302, e.g., by reducing the likelihood of over-fitting. As another example, the training engine 316 can regularize the training of the neural network 302 by including a “penalty” term in the objective function that measures the magnitude of the model parameter values 322 and 326 of the trained subnetworks 304 and 312. The penalty term can be, e.g., an L₁ or L₂ norm of the model parameter values 322 of the first trained subnetwork 304 and/or the model parameter values 326 of the second trained subnetwork 312.

In some cases, the values of the intermediate outputs of the biological convolutional subnetwork 308 can have large magnitudes, e.g., as a result from the parameter values of the biological convolutional subnetwork 308 being derived from the weight values of the edges of the synaptic connectivity graph rather than being trained. Therefore, to facilitate training of the neural network 302, batch normalization layers can be included between the layers of the biological convolutional subnetwork 308, which can contribute to limiting the magnitudes of intermediate outputs generated by the biological convolutional subnetwork 308. Alternatively or in combination, the activation functions of the biological convolutional subnetwork 308 can be selected to have a limited range. For example, the activation functions of the biological convolutional subnetwork 308 can be selected to be sigmoid activation functions with range given by [0,1].

The neural network 302 can be configured to perform any appropriate task. A few examples follow.

In one example, e.g., in implementations in which the biological convolutional subnetwork 308 includes a one-dimensional biological convolutional neural network layer, the neural network 302 can be configured to process network inputs 301 that represent sequences of audio data. For example, each input element in the network input 301 can be a raw audio sample or an input generated from a raw audio sample (e.g., a spectrogram), and the neural network 302 can process the sequence of input elements to generate network outputs 314 representing predicted text samples that correspond to the audio samples. That is, the neural network 302 can be a “speech-to-text” neural network. As another example, each input element can be a raw audio sample or an input generated from a raw audio sample, and the neural network 302 can generate a predicted class of the audio samples, e.g., a predicted identification of a speaker corresponding to the audio samples. As a particular example, the predicted class of the audio sample can represent a prediction of whether the input audio example is a verbalization of a predefined work or phrase, e.g., a “wakeup” phrase of a mobile device. In some implementations, one or more convolutional kernels of the biological convolutional subnetwork 308 can be generated from a subgraph of the synaptic connectivity graph corresponding to an audio region of the brain, i.e., a region of the brain that processes auditory information (e.g., the auditory cortex).

In another example, e.g., in implementations in which the biological convolutional subnetwork 308 includes a one-dimensional biological convolutional neural network layer, the neural network 302 can be configured to process network inputs 301 that represent sequences of text data. For example, each input element in the network input 301 can be a text sample (e.g., a character, phoneme, or word) or an embedding of a text sample, and the neural network 302 can process the sequence of input elements to generate network outputs 314 representing predicted audio samples that correspond to the text samples. That is, the neural network 302 can be a “text-to-speech” neural network. As another example, each input element can be an input text sample or an embedding of an input text sample, and the neural network 302 can generate a network output 314 representing a sequence of output text samples corresponding to the sequences of input text samples. As a particular example, the output text samples can represent the same text as the input text samples in a different language (i.e., the neural network 302 can be a machine translation neural network). As another particular example, the output text samples can represent an answer to a question posed by the input text samples (i.e., the neural network 302 can be a question-answering neural network). As another example, the input text samples can represent two texts (e.g., as separated by a delimiter token), and the neural network 302 can generate a network output representing a predicted similarity between the two texts. In some implementations, one or more convolutional kernels of the biological convolutional subnetwork 308 can be generated from a subgraph of the synaptic connectivity graph corresponding to a speech region of the brain, i.e., a region of the brain that is linked to speech production (e.g., Broca's area).

In another example, e.g., in implementations in which the biological convolutional subnetwork 308 includes a two-dimensional biological convolutional neural network layer, the neural network 302 can be configured to process network inputs 301 representing one or more images, e.g., sequences of video frames. For example, each input element in the network input 301 can be a video frame or an embedding of a video frame, and the neural network 302 can process the sequence of input elements to generate a network output 314 representing a prediction about the video represented by the sequence of video frames. As a particular example, the neural network 302 can be configured to track a particular object in each of the frames of the video, i.e., to generate a network output 314 that includes a sequences of output elements, where each output elements represents a predicted location within a respective video frames of the particular object. In some implementations, the biological convolutional subnetwork 308 can be generated from a subgraph of the synaptic connectivity graph corresponding to a visual region of the brain, i.e., a region of the brain that processes visual information (e.g., the visual cortex).

In another example, the neural network 302 can be configured to process a network input 301 representing a respective current state of an environment at each of one or more time points, and to generate a network output 314 representing action selection outputs that can be used to select actions to be performed at respective time points by an agent interacting with the environment. For example, each action selection output can specify a respective score for each action in a set of possible actions that can be performed by the agent, and the agent can select the action to be performed by sampling an action in accordance with the action scores. In one example, the agent can be a mechanical agent interacting with a real-world environment to perform a navigation task (e.g., reaching a goal location in the environment), and the actions performed by the agent cause the agent to navigate through the environment.

In this specification, an embedding is an ordered collection of numeric values that represents an input in a particular embedding space. For example, an embedding can be a vector of floating point or other numeric values that has a fixed dimensionality.

After training, the neural network 302 can be directly applied to perform prediction tasks. For example, the neural network 302 can be deployed onto a user device. In some implementations, the neural network 302 can be deployed directly into resource-constrained environments (e.g., mobile devices). Neural networks 302 that include biological convolutional subnetworks 308 can generally perform at a high level, e.g., in terms of prediction accuracy, even with very few model parameters compared to other neural networks. For example, neural networks 302 as described in this specification that have, e.g., 100 or 1000 model parameters can achieve comparable performance to other neural networks that have millions of model parameters. Thus, the neural network 302 can be implemented efficiently and with low latency on user devices.

In some implementations, after the neural network 302 has been deployed onto a user device, some of the parameters of the neural network 302 can be further trained, i.e., “fine-tuned,” using new training example obtained by the user device. For example, some of the parameters can be fine-tuned using training example corresponding to the specific user of the user device, so that the neural network 302 can achieve a higher accuracy for inputs provided by the specific user. As a particular example, the model parameters 322 of the first trained subnetwork 304 and/or the model parameters 326 of the second trained subnetwork 312 can be fine-tuned on the user device using new training examples while the model parameters 324 of the biological convolutional subnetwork 308 are held static, as described above.

FIG. 4A illustrates an example recurrent neural network 401 that includes a biological convolutional neural network layer 405. The recurrent neural network 401 is an example of a system implemented as computer programs on one or more computers in one or more locations in which the systems, components, and techniques described below are implemented.

The recurrent neural network 401 is configured to process, at each time step in a sequence of multiple time steps, (i) a previous hidden state 403 generated at the previous time step in the sequence of time step and (ii) a current network input 402 corresponding to the current time step, and to generate (i) a current network output 407 corresponding to the current time step and (ii) an updated hidden state 408 corresponding to the current time step. In some implementations, the current network output 407 and the updated hidden state 408 are the same. In some other implementations, the current network output 407 and the updated hidden state 408 are different.

The recurrent neural network 401 includes a biological convolutional neural network layer 405 that is configured, at each time step of the recurrent neural network 401, to process a biological convolutional neural network layer input 404 using a convolutional kernel to generate a biological convolutional neural network layer output 406. The convolutional kernel has been generated using the synaptic connectivity between neurons in the brain of a biological organism.

In some implementations, at each time step of the recurrent neural network 401, the biological convolutional neural network layer 405 can process the layer input 404 using a different convolutional kernel. That is, in the first time step the biological convolutional neural network layer 405 processes the layer input 404 using a first convolutional kernel, in the second time step the biological convolutional neural network layer 405 processes the layer input 404 using a different, second convolutional kernel, and so on.

For example, at each time step of the recurrence, the convolutional kernel used by the biological convolutional neural network layer 405 can be generated using the synaptic connectivity of a different neuron, e.g., a different row or layer of the adjacency matrix of the synaptic connectivity graph, as described above with reference to FIG. 2. For example, at the i^{th} time step of the recurrence, the biological convolutional neural network layer 405 can use a convolutional kernel generated from the i^{th} row or column of the adjacency matrix.

As another example, at each time step of the recurrence, the biological convolutional neural network layer 405 can use a convolutional kernel generated from a different neuron along a neuronal path through the brain of the biological organism. For example, as described above, the neuronal path can be selected such that it simulates the movement of a particular type of information through the brain of the biological organism through time. As a particular example, at each time point of the recurrence, the biological convolutional neural network layer 405 can use a convolutional kernel generated from a neuron that is closer to the center of the brain than the previous neuron in the neuronal path through the brain.

In some implementations, a training system can select the sequence of convolutional kernels (i.e., sequence of neurons along the neuronal path through the brain of the biological organism) using a hyperparameter search algorithm. That is, the sequence of convolutional kernels used at respective time point of the recurrence can be treated as a hyperparameter of the training of the recurrent neural network 400.

In some implementations, the convolutional kernels of the biological convolutional neural network layer 405 can be generates using the synaptic connectivity between neurons of a particular type in the brain, e.g., neurons from the visual system or the olfactory system, as described above.

After the final time step, the recurrent neural network 401 can provide a final network output. In some implementations, the output of the recurrent neural network 401 is the sequence of generated network outputs 407. In some other implementations, the output of the recurrent neural network 401 is a subset of the generated network outputs, e.g., the final generated network output 407 corresponding to the final time step. In some other implementations, the sequence of generated network outputs 407 is further processed to generate a final output. For example, the output of the recurrent neural network 401 can be the mean of the generated network outputs 407.

A recurrent neural network that includes biological convolutional neural network layers is discussed in more detail below with reference to FIG. 4B.

FIG. 4B illustrates an example recurrent neural network 400 that includes biological convolutional subnetworks 410 and 430. The recurrent neural network 400 is an example of a system implemented as computer programs on one or more computers in one or more locations in which the systems, components, and techniques described below are implemented. The recurrent neural network 400 has three subnetworks: (i) a first biological convolutional subnetwork 410 (ii) a second biological convolutional subnetwork 430, and (iii) a trained subnetwork 420. In some implementations, the parameters of the biological convolutional subnetworks 410 and/or 430 are not trained, as described above with respect to FIG. 3. For example, the parameters of the biological convolutional subnetworks 410 and/or 430 can be determine using the adjacency matrix of a synaptic connectivity graph, as described above with reference to FIG. 2.

The recurrent neural network 400 is configured to process, at each time step in a sequence of multiple time steps, (i) a previous hidden state 411 generated at the previous time step in the sequence of time step and (ii) a current network input 421 corresponding to the current time step, and to generate (i) a current network output 442 corresponding to the current time step and (ii) an updated hidden state 444 corresponding to the current time step.

More specifically, the first biological convolutional subnetwork 410 is configured to receive the previous hidden state 411 and to process the previous hidden state 411 to generate a representation 412 of the previous hidden state. The trained subnetwork 420 is configured to receive the current network input 421 and to process the current network input 421 to generate a representation 422 of the current network input. The second biological convolutional subnetwork 430 is configured to receive the representation 422 of the current network input and to process the representation 422 of the current network input to generate an updated representation 432 of the current network input.

The biological convolutional subnetworks 410 and 430 can each have an architecture that is based on a graph representing synaptic connectivity between neurons in the brain of a biological organism. For example, the biological convolutional subnetworks 410 and 430 can have been determined according to the process described above with respect to FIG. 2. In some implementations, the biological convolutional subnetworks 410 and 430 have the same network architecture and same parameter values. In some other implementations, the biological convolutional subnetworks 410 and 430 have different parameter values and/or different architectures.

In some implementations, the trained subnetwork 420 includes only one or a few neural network layers (e.g., a single fully-connected layer).

The recurrent neural network 400 also includes a combination engine 440 that is configured to combine (i) the representation 412 of the previous hidden state and (ii) the updated representation 432 of the current network input, generating (i) the current network output 442 and (ii) the updated hidden state 444.

In some implementations, the combination engine 440 combines the representation 412 of the previous hidden state and the updated representation 432 of the current network input using a second trained subnetwork. In some other implementations, the combination engine adds, multiplies, or concatenates the representation 412 and the updated representation 432 to generate an initial combined representation, and then processes the initial combined representation using an activation function (e.g., a Tanh function, a RELU function, or a Leaky RELU function) to generate the current network output 442 and the updated hidden state 444.

In some implementations, the current network output 442 and the updated hidden state 444 are the same. In some other implementations, the current network output 442 and the updated hidden state 444 are different. For example, the combination engine 440 can generate the current network output 442 and the updated hidden state 444 using respective different trained subnetworks.

As a particular example, each network input 421 can represent audio data, and each network output 442 can represent a prediction about the audio data represented by the corresponding network input 421, e.g., a prediction of a text sample (e.g., a grapheme, phoneme, character, word fragment, or word) represented by the audio data. In this example, the network input 421 can be any data that represents audio. For example, the network input 421 can include one or more of: a one-dimensional raw audio sample, a raw spectrogram generated from the audio sample, a Mel spectrogram generated from the audio sample, or a mel-frequency cepstral coefficient (MFCC) representation of the audio sample.

In some implementations, each network input 421 represents a current audio sample and one or more previous audio samples corresponding to respective previous time steps. For example, the network input 421 can be a spectrogram, e.g., a Mel spectrogram, that represents the current time step and the one or more previous time steps. Thus, the sequence of network inputs 421 can represent a sliding window of multiple time steps of audio data.

In some implementations, the output of the recurrent neural network 400 is the sequence of generated network outputs 442. In some other implementations, the output of the recurrent neural network 400 is a subset of the generated network outputs, e.g., the final generated network output 442 corresponding to the final time step. In some other implementations, the sequence of generated network outputs 442 is further processed to generate a final output. For example, the output of the recurrent neural network 400 can be the mean of the generated network outputs 442.

As a particular example, the final output of the recurrent neural network can be a prediction of whether a particular word or phrase was represented by the sequence of network inputs 421, e.g., a “wakeup” phrase of a mobile device that causes the mobile device to turn on in response to a verbal prompt from the user.

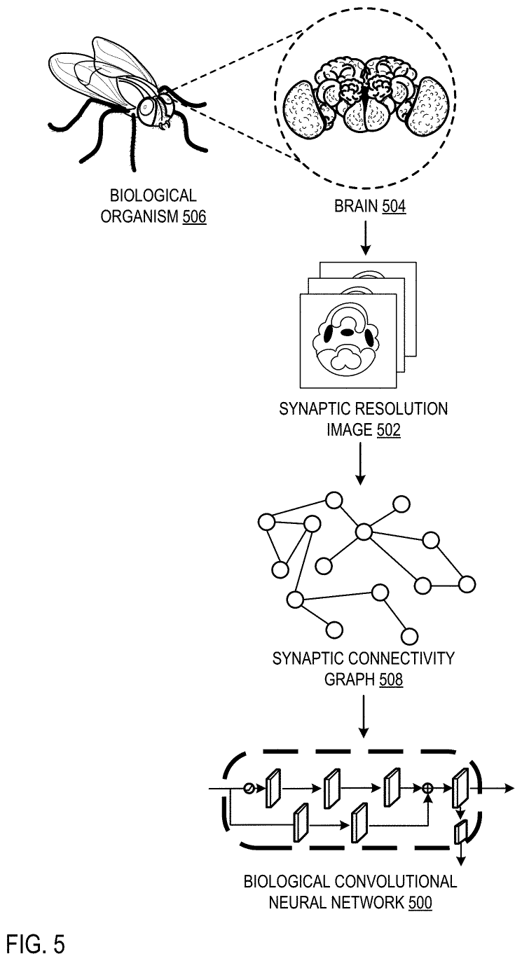

FIG. 5 illustrates an example of generating an artificial (i.e., computer-implemented) “biological convolutional” neural network 500 based on a synaptic resolution image 502 of the brain 504 of a biological organism 506, e.g., a fly. The synaptic resolution image 502 can be processed to generate a synaptic connectivity graph 508, e.g., where each node of the graph 508 corresponds to a neuron in the brain 504, and two nodes in the graph 508 are connected if the corresponding neurons in the brain 504 share a synaptic connection. The structure of the graph 508 can be used to generate convolutional kernels of the biological convolutional neural network 500.

The brains of biological organisms may be adapted by evolutionary pressures to be effective at solving certain tasks, e.g., classifying objects or generating robust object representations, and convolutional kernels generated using synaptic connectivity can share this capacity to effectively solve tasks. In particular, compared to other neural networks, e.g., with manually specified neural network architectures, biological convolutional neural networks can require less training data, fewer training iterations, or both, to effectively solve certain tasks. Moreover, biological convolutional neural networks can perform certain machine learning tasks more effectively, e.g., with higher accuracy, than other neural networks.

The systems described in this specification can process a synaptic connectivity graph corresponding to a brain to select for neural populations with a particular function (e.g., sensor function, memory function, executive, and the like). In this specification, neurons that have the same function are referred to as being neurons with the same neuronal “type”. In particular, features can be computed for each node in the graph (e.g., the path length corresponding to the node and the number of edges connected to the node), and the node features can be used to classify certain nodes as corresponding to a particular type of function, i.e., to a particular type of neuron in the brain. A sub-graph of the overall graph corresponding to neurons that are predicted to be of a certain type can be identified, and a biological convolutional neural network can be implemented using convolutional kernels generated from the sub-graph, i.e., rather than the entire graph. Convolutional kernels generated from a sub-graph corresponding to neurons of a certain type can enable the biological convolutional neural network to perform certain tasks more effectively while consuming fewer computational resources (e.g., memory and computing power). In one example, the biological convolutional neural network can be configured to perform image processing tasks, and the convolutional kernels can be generated from a sub-graph corresponding to only the visual system of the brain (i.e., to visual system neurons). In another example, the biological convolutional neural network can be configured to perform audio processing tasks, and the convolutional kernels can be generated from a sub-graph corresponding to only the audio system of the brain (i.e., to audio system neurons).

FIG. 6 shows an example data flow 600 for generating a synaptic connectivity graph 602 and a biological convolutional neural network 604 based on the brain 606 of a biological organism. As used throughout this document, a brain may refer to any amount of nervous tissue from a nervous system of a biological organism, and nervous tissue may refer to any tissue that includes neurons (i.e., nerve cells). The biological organism can be, e.g., a worm, a fly, a mouse, a cat, or a human.

An imaging system 608 can be used to generate a synaptic resolution image 610 of the brain 606. An image of the brain 606 may be referred to as having synaptic resolution if it has a spatial resolution that is sufficiently high to enable the identification of at least some synapses in the brain 606. Put another way, an image of the brain 606 may be referred to as having synaptic resolution if it depicts the brain 606 at a magnification level that is sufficiently high to enable the identification of at least some synapses in the brain 606. The image 610 can be a volumetric image, i.e., that characterizes a three-dimensional representation of the brain 606. The image 610 can be represented in any appropriate format, e.g., as a three-dimensional array of numerical values.

The imaging system 608 can be any appropriate system capable of generating synaptic resolution images, e.g., an electron microscopy system. The imaging system 608 can process “thin sections” from the brain 606 (i.e., thin slices of the brain attached to slides) to generate output images that each have a field of view corresponding to a proper subset of a thin section. The imaging system 608 can generate a complete image of each thin section by stitching together the images corresponding to different fields of view of the thin section using any appropriate image stitching technique. The imaging system 608 can generate the volumetric image 610 of the brain by registering and stacking the images of each thin section. Registering two images refers to applying transformation operations (e.g., translation or rotation operations) to one or both of the images to align them. Example techniques for generating a synaptic resolution image of a brain are described with reference to: Z. Zheng, et al., “A complete electron microscopy volume of the brain of adult Drosophila melanogaster,” Cell 174, 730-743 (2018).

A graphing system 612 is configured to process the synaptic resolution image 610 to generate the synaptic connectivity graph 602. The synaptic connectivity graph 602 specifies a set of nodes and a set of edges, such that each edge connects two nodes. To generate the graph 602, the graphing system 612 identifies each neuron in the image 610 as a respective node in the graph, and identifies each synaptic connection between a pair of neurons in the image 610 as an edge between the corresponding pair of nodes in the graph.

The graphing system 612 can identify the neurons and the synapses depicted in the image 610 using any of a variety of techniques. For example, the graphing system 612 can process the image 610 to identify the positions of the neurons depicted in the image 610, and determine whether a synapse connects two neurons based on the proximity of the neurons (as will be described in more detail below). In this example, the graphing system 612 can process an input including: (i) the image, (ii) features derived from the image, or (iii) both, using a machine learning model that is trained using supervised learning techniques to identify neurons in images. The machine learning model can be, e.g., a convolutional neural network model or a random forest model. The output of the machine learning model can include a neuron probability map that specifies a respective probability that each voxel in the image is included in a neuron. The graphing system 612 can identify contiguous clusters of voxels in the neuron probability map as being neurons.

Optionally, prior to identifying the neurons from the neuron probability map, the graphing system 612 can apply one or more filtering operations to the neuron probability map, e.g., with a Gaussian filtering kernel. Filtering the neuron probability map can reduce the amount of “noise” in the neuron probability map, e.g., where only a single voxel in a region is associated with a high likelihood of being a neuron.

The machine learning model used by the graphing system 612 to generate the neuron probability map can be trained using supervised learning training techniques on a set of training data. The training data can include a set of training examples, where each training example specifies: (i) a training input that can be processed by the machine learning model, and (ii) a target output that should be generated by the machine learning model by processing the training input. For example, the training input can be a synaptic resolution image of a brain, and the target output can be a “label map” that specifies a label for each voxel of the image indicating whether the voxel is included in a neuron. The target outputs of the training examples can be generated by manual annotation, e.g., where a person manually specifies which voxels of a training input are included in neurons.

Example techniques for identifying the positions of neurons depicted in the image 610 using neural networks (in particular, flood-filling neural networks) are described with reference to: P. H. Li et al.: “Automated Reconstruction of a Serial-Section EM Drosophila Brain with Flood-Filling Networks and Local Realignment,” bioRxiv doi:10.1101/605634 (2019).

The graphing system 612 can identify the synapses connecting the neurons in the image 610 based on the proximity of the neurons. For example, the graphing system 612 can determine that a first neuron is connected by a synapse to a second neuron based on the area of overlap between: (i) a tolerance region in the image around the first neuron, and (ii) a tolerance region in the image around the second neuron. That is, the graphing system 612 can determine whether the first neuron and the second neuron are connected based on the number of spatial locations (e.g., voxels) that are included in both: (i) the tolerance region around the first neuron, and (ii) the tolerance region around the second neuron. For example, the graphing system 612 can determine that two neurons are connected if the overlap between the tolerance regions around the respective neurons includes at least a predefined number of spatial locations (e.g., one spatial location). A “tolerance region” around a neuron refers to a contiguous region of the image that includes the neuron. For example, the tolerance region around a neuron can be specified as the set of spatial locations in the image that are either: (i) in the interior of the neuron, or (ii) within a predefined distance of the interior of the neuron.

The graphing system 612 can further identify a weight value associated with each edge in the graph 602. For example, the graphing system 612 can identify a weight for an edge connecting two nodes in the graph 602 based on the area of overlap between the tolerance regions around the respective neurons corresponding to the nodes in the image 610. The area of overlap can be measured, e.g., as the number of voxels in the image 610 that are contained in the overlap of the respective tolerance regions around the neurons. The weight for an edge connecting two nodes in the graph 602 may be understood as characterizing the (approximate) strength of the connection between the corresponding neurons in the brain (e.g., the amount of information flow through the synapse connecting the two neurons).

In addition to identifying synapses in the image 610, the graphing system 612 can further determine the direction of each synapse using any appropriate technique. The “direction” of a synapse between two neurons refers to the direction of information flow between the two neurons, e.g., if a first neuron uses a synapse to transmit signals to a second neuron, then the direction of the synapse would point from the first neuron to the second neuron. Example techniques for determining the directions of synapses connecting pairs of neurons are described with reference to: C. Seguin, A. Razi, and A. Zalesky: “Inferring neural signalling directionality from undirected structure connectomes,” Nature Communications 10, 4289 (2019), doi:10.1038/s41467-019-12201-w.

In implementations where the graphing system 612 determines the directions of the synapses in the image 610, the graphing system 612 can associate each edge in the graph 602 with the direction of the corresponding synapse. That is, the graph 602 can be a directed graph. In some other implementations, the graph 602 can be an undirected graph, i.e., where the edges in the graph are not associated with a direction.

The graph 602 can be represented in any of a variety of ways. For example, the graph 602 can be represented as a two-dimensional array of numerical values with a number of rows and columns equal to the number of nodes in the graph The component of the array at position (i,j) can have value 1 if the graph includes an edge pointing from node i to node j, and value 0 otherwise. In implementations where the graphing system 612 determines a weight value for each edge in the graph 602, the weight values can be similarly represented as a two-dimensional array of numerical values. More specifically, if the graph includes an edge connecting node i to node j, the component of the array at position (i,j) can have a value given by the corresponding edge weight, and otherwise the component of the array at position (i,j) can have value 0.

A kernel generation system 620 can process the synaptic connectivity graph 602 to generate the convolutional kernel for a biological convolutional neural network layer of the biological convolutional neural network 604. Example techniques for generating convolutional kernels using a synaptic connectivity graph is described above with reference to FIG. 2. As a particular example, one or more nodes in the graph 602 can correspond to respective different convolutional neural network layers, where the convolutional kernels for the convolutional neural network layers are generated using the synaptic connectivity between the neuron represented by the node and the other neurons in the brain of the biological organism, as described above.

The kernel generation system 620 can further map each edge of the graph 602 to a connection in the biological convolutional neural network 604, e.g., such that a first biological convolutional neural network layer (corresponding to a first node in the graph 602) that is connected to a second biological convolutional neural network layer (corresponding to a second node in the graph 602) is configured to provide its layer output to the second artificial neuron, where the first node and the second node share an edge in the graph 602. For example, a convolutional neural network layer corresponding to a first node in the graph 602 can provide its layer output to convolutional neural network layers corresponding to nodes in the graph 602 that share an edge with the first node.

In some implementations, the kernel generation system 620 can apply one or more transformation operations to the graph 602 before mapping the nodes and edges of the graph 602 to corresponding components in the architecture of the biological convolutional neural network 604, as will be described in more detail below. An example kernel generation system is described in more detail below with reference to FIG. 7.

The biological convolutional neural network 604 can be provided to a training system 614 that trains the biological convolutional neural network using machine learning techniques, i.e., generates an update to the respective values of one or more parameters of the biological convolutional neural network. In particular, the training system 614 can generate parameter updates for the machine-learned neural network layers of the biological convolutional neural network 604, while keeping the parameters of the convolutional kernels of the biological convolutional neural network layers constant.

In some implementations, the training system 614 is a supervised training system that is configured to train the biological convolutional neural network 604 using a set of training data. The training data can include multiple training examples, where each training example specifies: (i) a training input, and (ii) a corresponding target output that should be generated by the biological convolutional neural network 604 by processing the training input. In one example, the direct training system 614 can train the biological convolutional neural network 604 over multiple training iterations using a gradient descent optimization technique, e.g., stochastic gradient descent. In this example, at each training iteration, the direct training system 614 can sample a “batch” (set) of one or more training examples from the training data, and process the training inputs specified by the training examples to generate corresponding network outputs. The direct training system 614 can evaluate an objective function that measures a similarity between: (i) the target outputs specified by the training examples, and (ii) the network outputs generated by the biological convolutional neural network, e.g., a cross-entropy or squared-error objective function. The direct training system 614 can determine gradients of the objective function, e.g., using backpropagation techniques, and update the parameter values of the biological convolutional neural network 604 using the gradients, e.g., using any appropriate gradient descent optimization algorithm, e.g., RMSprop or Adam.

In some other implementations, the training system 614 is an adversarial training system that is configured to train the biological convolutional neural network 604 in an adversarial fashion. For example, the training system 614 can include a discriminator neural network that is configured to process network outputs generated by the biological convolutional neural network 604 to generate a prediction of whether the network outputs are “real” outputs (i.e., outputs that were not generated by the biological convolutional neural network, e.g., outputs that represent data that was captured from the real world) or “synthetic” outputs (i.e., outputs generated by the biological convolutional neural network 604). The training system can then determine an update to the parameters of the biological convolutional neural network in order to increase an error in the prediction of the discriminator neural network; that is, the goal of the biological convolutional neural network is to generate synthetic outputs that are realistic enough that the discriminator neural network predicts them to be real outputs. In some implementations, concurrently with training the biological convolutional neural network 604, the training system 614 generates updates to the parameters of the discriminator neural network.

In some other implementations, the training system 614 is a distillation training system that is configured to use the biological convolutional neural network 604 to facilitate training of a “student” neural network having a less complex architecture than the biological convolutional neural network 604. The complexity of a neural network architecture can be measured, e.g., by the number of parameters required to specify the operations performed by the neural network. The training system 614 can train the student neural network to match the outputs generated by the biological convolutional neural network. After training, the student neural network can inherit the capacity of the biological convolutional neural network 604 to effectively solve certain tasks, while consuming fewer computational resources (e.g., memory and computing power) than the biological convolutional neural network 604. Typically, the training system 614 does not update the parameters of the biological convolutional neural network 604 while training the student neural network. That is, in these implementations, the training system 614 is configured to train the student neural network instead of the biological convolutional neural network 604.

As a particular example, the training system 614 can be a distillation training system that trains the student neural network in an adversarial manner. For example, the training system 614 can include a discriminator neural network that is configured to process network outputs that were generated either by the biological convolutional neural network 604 or the student neural network, and to generate a prediction of whether the network outputs where generated by the biological convolutional neural network 604 or the student neural network. The training system can then determine an update to the parameters of the student neural network in order to increase an error in the prediction of the discriminator neural network; that is, the goal of the student neural network is to generate network outputs that resemble network outputs generated by the biological convolutional neural network 602 so that the discriminator neural network predicts that they were generated by the biological convolutional neural network 604.

After the training system 614 has completed training the biological convolutional neural network 604 (or a neural network that includes the biological convolutional neural network as a subnetwork, or a student neural network trained using the biological convolutional neural network), the biological convolutional neural network 604 can be deployed by a deployment system 622. That is, the operations of the biological convolutional neural network 604 can be implemented on a device or a system of devices for performing inference, i.e., receiving network inputs and processing the network inputs to generate network outputs. In some implementations, the biological convolutional neural network 604 can be deployed onto a cloud system, i.e., a distributed computing system having multiple computing nodes, e.g., hundreds or thousands of computing nodes, in one or more locations. In some other implementations, the biological convolutional neural network 604 can be deployed onto a user device.

FIG. 7 shows an example kernel generation system 700. The kernel generation system 700 is an example of a system implemented as computer programs on one or more computers in one or more locations in which the systems, components, and techniques described below are implemented.

The kernel generation system 700 is configured to process a synaptic connectivity graph 701 (e.g., the synaptic connectivity graph 602 depicted in FIG. 6) to generate a convolutional kernel 702 of a biological convolutional neural network 716 (e.g., the biological convolutional neural network 604 depicted in FIG. 6). The kernel generation system 700 can generate the convolutional kernel 702 using one or more of: a transformation engine 704, a feature generation engine 706, a node classification engine 708, and a nucleus classification engine 718, which will each be described in more detail next.

The transformation engine 704 can be configured to apply one or more transformation operations to the synaptic connectivity graph 701 that alter the connectivity of the graph 701, i.e., by adding or removing edges from the graph. A few examples of transformation operations follow.

In one example, to apply a transformation operation to the graph 701, the transformation engine 704 can randomly sample a set of node pairs from the graph (i.e., where each node pair specifies a first node and a second node). For example, the transformation engine can sample a predefined number of node pairs in accordance with a uniform probability distribution over the set of possible node pairs. For each sampled node pair, the transformation engine 704 can modify the connectivity between the two nodes in the node pair with a predefined probability (e.g., 0.1%). In one example, the transformation engine 704 can connect the nodes by an edge (i.e., if they are not already connected by an edge) with the predefined probability. In another example, the transformation engine 704 can reverse the direction of any edge connecting the two nodes with the predefined probability. In another example, the transformation engine 704 can invert the connectivity between the two nodes with the predefined probability, i.e., by adding an edge between the nodes if they are not already connected, and by removing the edge between the nodes if they are already connected.

In another example, the transformation engine 704 can apply a convolutional filter to a representation of the graph 701 as a two-dimensional array of numerical values. As described above, the graph 701 can be represented as a two-dimensional array of numerical values where the component of the array at position (i,j) can have value 1 if the graph includes an edge pointing from node i to node j, and value 0 otherwise. The convolutional filter can have any appropriate kernel, e.g., a spherical kernel or a Gaussian kernel. After applying the convolutional filter, the transformation engine 704 can quantize the values in the array representing the graph, e.g., by rounding each value in the array to 0 or 1, to cause the array to unambiguously specify the connectivity of the graph. Applying a convolutional filter to the representation of the graph 701 can have the effect of regularizing the graph, e.g., by smoothing the values in the array representing the graph to reduce the likelihood of a component in the array having a different value than many of its neighbors.

In some cases, the graph 701 can include some inaccuracies in representing the synaptic connectivity in the biological brain. For example, the graph can include nodes that are not connected by an edge despite the corresponding neurons in the brain being connected by a synapse, or “spurious” edges that connect nodes in the graph despite the corresponding neurons in the brain not being connected by a synapse. Inaccuracies in the graph can result, e.g., from imaging artifacts or ambiguities in the synaptic resolution image of the brain that is processed to generate the graph. Regularizing the graph, e.g., by applying a convolutional filter to the representation of the graph, can increase the accuracy with which the graph represents the synaptic connectivity in the brain, e.g., by removing spurious edges.

The kernel generation system 700 can use the feature generation engine 706 and the node classification engine 708 to determine predicted “types” 710 of the neurons corresponding to the nodes in the graph 701. The type of a neuron can characterize any appropriate aspect of the neuron. In one example, the type of a neuron can characterize the function performed by the neuron in the brain, e.g., a visual function by processing visual data, an olfactory function by processing odor data, or a memory function by retaining information. After identifying the types of the neurons corresponding to the nodes in the graph 701, the kernel generation system 700 can identify a sub-graph 712 of the overall graph 701 based on the neuron types, and determine the convolutional kernel 702 based on the sub-graph 712. The feature generation engine 706 and the node classification engine 708 are described in more detail next.

The feature generation engine 706 can be configured to process the graph 701 (potentially after it has been modified by the transformation engine 704) to generate one or more respective node features 714 corresponding to each node of the graph 701. The node features corresponding to a node can characterize the topology (i.e., connectivity) of the graph relative to the node. In one example, the feature generation engine 706 can generate a node degree feature for each node in the graph 701, where the node degree feature for a given node specifies the number of other nodes that are connected to the given node by an edge. In another example, the feature generation engine 706 can generate a path length feature for each node in the graph 701, where the path length feature for a node specifies the length of the longest path in the graph starting from the node. A path in the graph may refer to a sequence of nodes in the graph, such that each node in the path is connected by an edge to the next node in the path. The length of a path in the graph may refer to the number of nodes in the path. In another example, the feature generation engine 706 can generate a neighborhood size feature for each node in the graph 701, where the neighborhood size feature for a given node specifies the number of other nodes that are connected to the node by a path of length at most N. In this example, N can be a positive integer value. In another example, the feature generation engine 706 can generate an information flow feature for each node in the graph 701. The information flow feature for a given node can specify the fraction of the edges connected to the given node that are outgoing edges, i.e., the fraction of edges connected to the given node that point from the given node to a different node.

In some implementations, the feature generation engine 706 can generate one or more node features that do not directly characterize the topology of the graph relative to the nodes. In one example, the feature generation engine 706 can generate a spatial position feature for each node in the graph 701, where the spatial position feature for a given node specifies the spatial position in the brain of the neuron corresponding to the node, e.g., in a Cartesian coordinate system of the synaptic resolution image of the brain. In another example, the feature generation engine 706 can generate a feature for each node in the graph 701 indicating whether the corresponding neuron is excitatory or inhibitory. In another example, the feature generation engine 706 can generate a feature for each node in the graph 701 that identifies the neuropil region associated with the neuron corresponding to the node.

In some cases, the feature generation engine 706 can use weights associated with the edges in the graph in determining the node features 714. As described above, a weight value for an edge connecting two nodes can be determined, e.g., based on the area of any overlap between tolerance regions around the neurons corresponding to the nodes. In one example, the feature generation engine 706 can determine the node degree feature for a given node as a sum of the weights corresponding to the edges that connect the given node to other nodes in the graph. In another example, the feature generation engine 706 can determine the path length feature for a given node as a sum of the edge weights along the longest path in the graph starting from the node.

The node classification engine 708 can be configured to process the node features 714 to identify a predicted neuron type 710 corresponding to certain nodes of the graph 701. In one example, the node classification engine 708 can process the node features 714 to identify a proper subset of the nodes in the graph 701 with the highest values of the path length feature. For example, the node classification engine 708 can identify the nodes with a path length feature value greater than the 90th percentile (or any other appropriate percentile) of the path length feature values of all the nodes in the graph. The node classification engine 708 can then associate the identified nodes having the highest values of the path length feature with the predicted neuron type of “primary sensory neuron.” In another example, the node classification engine 708 can process the node features 714 to identify a proper subset of the nodes in the graph 701 with the highest values of the information flow feature, i.e., indicating that many of the edges connected to the node are outgoing edges. The node classification engine 708 can then associate the identified nodes having the highest values of the information flow feature with the predicted neuron type of “sensory neuron.” In another example, the node classification engine 708 can process the node features 714 to identify a proper subset of the nodes in the graph 701 with the lowest values of the information flow feature, i.e., indicating that many of the edges connected to the node are incoming edges (i.e., edges that point towards the node). The node classification engine 708 can then associate the identified nodes having the lowest values of the information flow feature with the predicted neuron type of “associative neuron.”

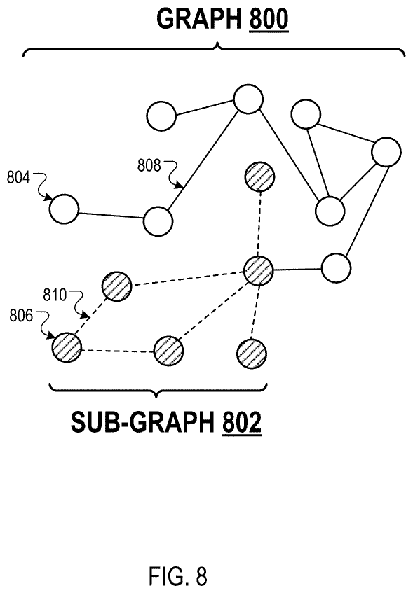

The kernel generation system 700 can identify a sub-graph 712 of the overall graph 701 based on the predicted neuron types 710 corresponding to the nodes of the graph 701. A “sub-graph” may refer to a graph specified by: (i) a proper subset of the nodes of the graph 701, and (ii) a proper subset of the edges of the graph 701. FIG. 8 provides an illustration of an example sub-graph of an overall graph. In one example, the kernel generation system 700 can select: (i) each node in the graph 701 corresponding to particular neuron type, and (ii) each edge in the graph 701 that connects nodes in the graph corresponding to the particular neuron type, for inclusion in the sub-graph 712. The neuron type selected for inclusion in the sub-graph can be, e.g., visual neurons, olfactory neurons, memory neurons, or any other appropriate type of neuron. In some cases, the kernel generation system 700 can select multiple neuron types for inclusion in the sub-graph 712, e.g., both visual neurons and olfactory neurons.

The type of neuron selected for inclusion in the sub-graph 712 can be determined based on the task which the biological convolutional neural network 716 will be configured to perform. In one example, the biological convolutional neural network 716 can be configured to perform an image processing task, and neurons that are predicted to perform visual functions (i.e., by processing visual data) can be selected for inclusion in the sub-graph 712. In another example, the biological convolutional neural network 716 can be configured to perform an odor processing task, and neurons that are predicted to perform odor processing functions (i.e., by processing odor data) can be selected for inclusion in the sub-graph 712. In another example, the biological convolutional neural network 716 can be configured to perform an audio processing task, and neurons that are predicted to perform audio processing (i.e., by processing audio data) can be selected for inclusion in the sub-graph 712.

If the edges of the graph 701 are associated with weight values (as described above), then each edge of the sub-graph 712 can be associated with the weight value of the corresponding edge in the graph 701. The sub-graph 712 can be represented, e.g., as a two-dimensional array of numerical values, as described with reference to the graph 701.

The kernel generation system 700 can process the sub-graph 712 using the nucleus classification engine 718 prior to generating the convolutional kernel 702. The nucleus classification engine 718 can be configured to process a representation of the sub-graph 712 as a two-dimensional array of numerical values (as described above) to identify one or more “clusters” in the array.

A cluster in the array representing the sub-graph 712 may refer to a contiguous region of the array such that at least a threshold fraction of the components in the region have a value indicating that an edge exists between the pair of nodes corresponding to the component. In one example, the component of the array in position (i,j) can have value 1 if an edge exists from node i to node j, and value 0 otherwise. In this example, the nucleus classification engine 718 can identify contiguous regions of the array such that at least a threshold fraction of the components in the region have the value 1. The nucleus classification engine 718 can identify clusters in the array representing the sub-graph 712 by processing the array using a blob detection algorithm, e.g., by convolving the array with a Gaussian kernel and then applying the Laplacian operator to the array. After applying the Laplacian operator, the nucleus classification engine 718 can identify each component of the array having a value that satisfies a predefined threshold as being included in a cluster.

Each of the clusters identified in the array representing the sub-graph 712 can correspond to edges connecting a “nucleus” (i.e., group) of related neurons in brain, e.g., a thalamic nucleus, a vestibular nucleus, a dentate nucleus, or a fastigial nucleus. After the nucleus classification engine 718 identifies the clusters in the array representing the sub-graph 712, the kernel generation system 700 can select one or more of the clusters for inclusion in the sub-graph 712. The kernel generation system 700 can select the clusters for inclusion in the sub-graph 712 based on respective features associated with each of the clusters. The features associated with a cluster can include, e.g., the number of edges (i.e., components of the array) in the cluster, the average of the node features corresponding to each node that is connected by an edge in the cluster, or both. In one example, the kernel generation system 700 can select a predefined number of largest clusters (i.e., that include the greatest number of edges) for inclusion in the sub-graph 712.

The kernel generation system 700 can reduce the sub-graph 712 by removing any edge in the sub-graph 712 that is not included in one of the selected clusters, and then generate the convolutional kernel 702 using the reduced sub-graph 712, as will be described in more detail below.

The kernel generation system 700 can generate the convolutional kernel 702 of the biological convolutional neural network 716 from the sub-graph 712 in any of a variety of ways. Some example techniques are described above with reference to FIG. 2.

Various operations performed by the described kernel generation system 700 are optional or can be implemented in a different order. For example, the kernel generation system 700 can refrain from applying transformation operations to the graph 701 using the transformation engine 704, and refrain from extracting a sub-graph 712 from the graph 701 using the feature generation engine 706, the node classification engine 708, and the nucleus classification engine 718. In this example, the kernel generation system 700 can directly generate the convolutional kernel 702 using the graph 701.

FIG. 8 illustrates an example graph 800 and an example sub-graph 802. Each node in the graph 800 is represented by a circle (e.g., 804 and 806), and each edge in the graph 800 is represented by a line (e.g., 808 and 810). In this illustration, the graph 800 can be considered a simplified representation of a synaptic connectivity graph (an actual synaptic connectivity graph can have far more nodes and edges than are depicted in FIG. 8). A sub-graph 802 can be identified in the graph 800, where the sub-graph 802 includes a proper subset of the nodes and edges of the graph 800. In this example, the nodes included in the sub-graph 802 are hatched (e.g., 806) and the edges included in sub-graph 802 are dashed (e.g., 810). The nodes included in the sub-graph 802 can correspond to neurons of a particular type, e.g., neurons having a particular function, e.g., olfactory neurons, visual neurons, or memory neurons. Emulation convolutional kernel of a biological convolutional neural network can be generated using the structure of the entire graph 800, or by the structure of a sub-graph 802, as described above.

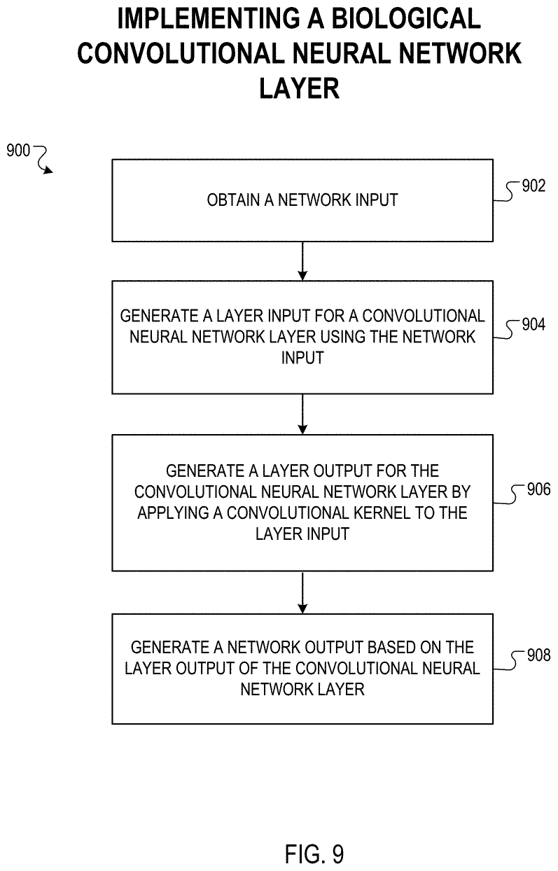

FIG. 9 is a flow diagram of an example process 900 for implementing a biological convolutional neural network layer. The biological neural network layer has a convolutional kernel that has been determined using synaptic connectivity. The biological convolutional neural network layer can be a component of any neural network. For convenience, the process 900 will be described as being performed by a system of one or more computers located in one or more locations. For example, a system executing a neural network, e.g., the neural network 302 depicted in FIG. 3, appropriately programmed in accordance with this specification, can perform the process 900.

The system obtains a network input for the neural network (step 902).

The system generates a layer input for the biological convolutional neural network layer using the network input (step 904). For example, the system can process the network input using a sequence of neural network layers that precede the biological convolutional neural network layer in the architecture of the neural network.

The system generates a layer output for the biological convolutional neural network layer by applying the convolutional kernel to the layer input (step 906). The convolutional kernel can correspond to a specified neuron in the brain of a biological organism, and values of the convolutional kernel parameters can be based on synaptic connectivity between the specified neuron and each of multiple other neurons in the brain of the biological organism. The convolutional kernel can have any appropriate dimensionality, e.g., the convolutional kernel can be one-, two-, or three-dimensional.

In some implementations, each convolutional kernel parameter corresponds to a respective other neuron in the brain of the biological organism, and for each other neuron that is connected to the specified neuron by a synaptic connection, the value of the corresponding convolutional kernel parameter is based on a proximity of the other neuron to the specified neuron in the brain of the biological organism. For example, a second system (e.g., the imaging system 608 depicted in FIG. 6) can determine the values for the convolutional kernel parameters by obtaining a synaptic resolution image of at least a portion of the brain of the biological organism and processing the image to identify i) the specified neuron, ii) the multiple other neurons, and iii) the synaptic connections between the specified neuron and the multiple other neurons. In some such implementations, the second system can further process the image to identify a respective direction of the synaptic connections between the specified neuron and the multiple other neurons, and, for each other neuron, determine the value for the convolutional kernel parameter corresponding to the other neuron using an identified synaptic connection that is directed from the specified neuron to the other neuron.

In some implementations, the neural network is a recurrent neural network that is configured to obtain a respective network input at each of multiple time steps. At each of the time steps, the biological convolutional neural network layer can process the layer input for the time step using a different convolutional kernel. The respective convolutional kernel for each time step can correspond to a different neuron in the brain of the biological organism. For example, the convolutional kernel for a first time step of the multiple time steps can correspond to a first neuron in the brain of the biological organism, and the convolutional kernel for a subsequent time step of the multiple time steps can correspond to a second neuron in the brain of the biological organism, where the second neuron shares a synaptic connection with the first neuron in the brain of the biological organism. As another example, the convolutional kernel for a first time step of the multiple time steps can correspond to a first neuron in the brain of the biological organism, and the convolutional kernel for a subsequent time step of the multiple time steps can correspond to a second neuron in the brain of the biological organism, where the second neuron is closer to a center of the brain than the first neuron.

The system generates a network output for the neural network based on the layer output of the biological convolutional neural network layer (step 908). For example, the system can process the layer output using a sequence of neural network layers that follow the biological convolutional neural network layer in the architecture of the neural network.

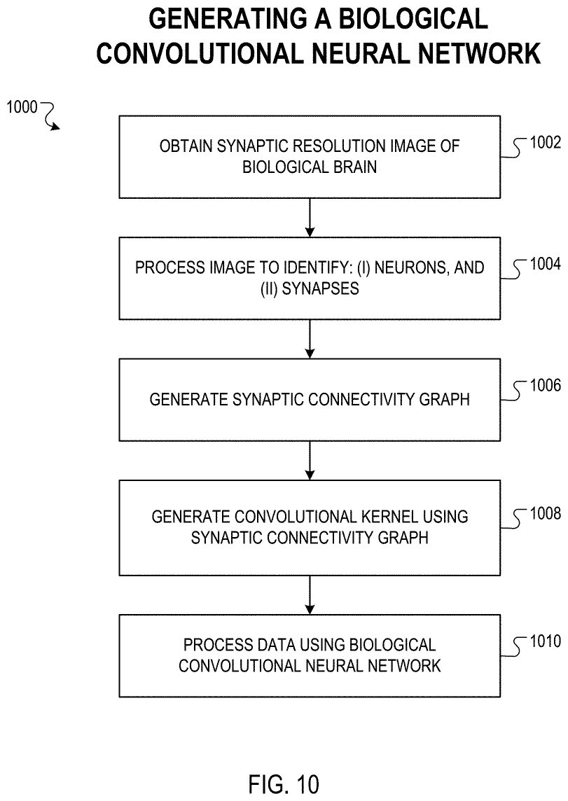

FIG. 10 is a flow diagram of an example process 1000 for generating a biological convolutional neural network. For convenience, the process 1000 will be described as being performed by a system of one or more computers located in one or more locations.

The system obtains a synaptic resolution image of at least a portion of a brain of a biological organism (1002).

The system processes the image to identify: (i) neurons in the brain, and (ii) synaptic connections between the neurons in the brain (1004).

The system generates data defining a graph representing synaptic connectivity between the neurons in the brain (1006). The graph includes a set of nodes and a set of edges, where each edge connects a pair of nodes. The system identifies each neuron in the brain as a respective node in the graph, and each synaptic connection between a pair of neurons in the brain as an edge between a corresponding pair of nodes in the graph.

The system generates a convolutional kernel using the graph representing the synaptic connectivity between the neurons in the brain (1008).

The system processes a network input using an biological convolutional neural network, including processing a layer input to a biological convolutional neural network layer using the generated convolutional kernel, to generate a network output (1010).

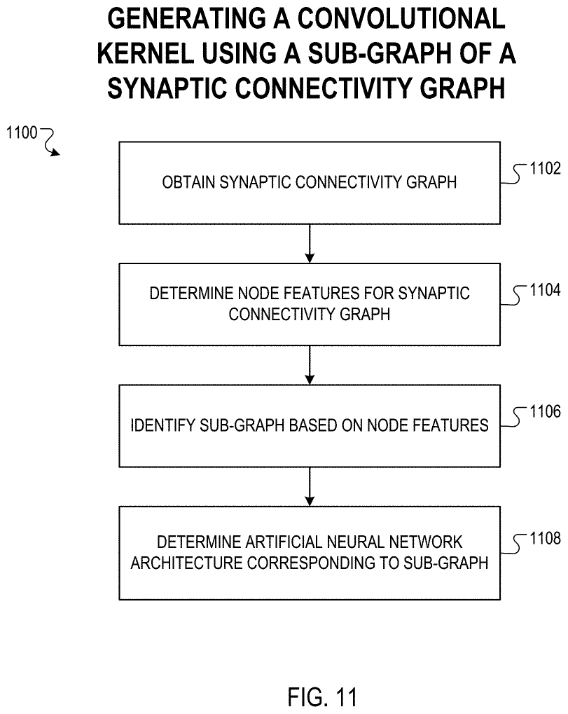

FIG. 11 is a flow diagram of an example process 1100 for generating a convolutional kernel using a sub-graph of a synaptic connectivity graph. For convenience, the process 1100 will be described as being performed by a system of one or more computers located in one or more locations. For example, mapping kernel generation system, e.g., the kernel generation system 700 of FIG. 7, appropriately programmed in accordance with this specification, can perform the process 1100.

The system obtains data defining a graph representing synaptic connectivity between neurons in a brain of a biological organism (1102). The graph includes a set of nodes and edges, where each edge connects a pair of nodes. Each node corresponds to a respective neuron in the brain of the biological organism, and each edge connecting a pair of nodes in the graph corresponds to a synaptic connection between a pair of neurons in the brain of the biological organism.

The system determines, for each node in the graph, a respective set of one or more node features characterizing a structure of the graph relative to the node (1104).

The system identifies a sub-graph of the graph (1106). In particular, the system selects a proper subset of the nodes in the graph for inclusion in the sub-graph based on the node features of the nodes in the graph.

The system generates a convolutional kernel using the sub-graph of the graph (1108).

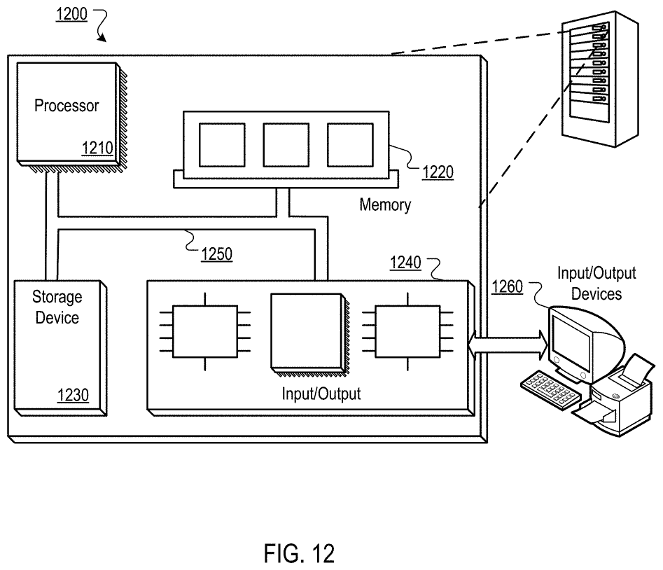

FIG. 12 is a block diagram of an example computer system 1200 that can be used to perform operations described previously. The system 1200 includes a processor 1210, a memory 1220, a storage device 1230, and an input/output device 1240. Each of the components 1210, 1220, 1230, and 1240 can be interconnected, for example, using a system bus 1250. The processor 1210 is capable of processing instructions for execution within the system 1200. In one implementation, the processor 1210 is a single-threaded processor. In another implementation, the processor 1210 is a multi-threaded processor. The processor 1210 is capable of processing instructions stored in the memory 1220 or on the storage device 1230.

The memory 1220 stores information within the system 1200. In one implementation, the memory 1220 is a computer-readable medium. In one implementation, the memory 1220 is a volatile memory unit. In another implementation, the memory 1220 is a non-volatile memory unit.

The storage device 1230 is capable of providing mass storage for the system 1200. In one implementation, the storage device 1230 is a computer-readable medium. In various different implementations, the storage device 1230 can include, for example, a hard disk device, an optical disk device, a storage device that is shared over a network by multiple computing devices (for example, a cloud storage device), or some other large capacity storage device.

The input/output device 1240 provides input/output operations for the system 1200. In one implementation, the input/output device 1240 can include one or more network interface devices, for example, an Ethernet card, a serial communication device, for example, and RS-232 port, and/or a wireless interface device, for example, and 802.11 card. In another implementation, the input/output device 1240 can include driver devices configured to receive input data and send output data to other input/output devices, for example, keyboard, printer and display devices 1260. Other implementations, however, can also be used, such as mobile computing devices, mobile communication devices, and set-top box television client devices.

Although an example processing system has been described in FIG. 12, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g., a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a method comprising:

obtaining a network input; and

processing the network input using a neural network to generate a network output, wherein the neural network comprises a convolutional neural network layer and is configured to perform operations comprising:
generating a layer input to the convolutional neural network layer based on the network input;
generating a layer output of the convolutional neural network layer based on the layer input, comprising applying a convolutional kernel having a plurality of convolutional kernel parameters to the layer input,
wherein the convolutional kernel corresponds to a specified neuron in a brain of a biological organism and values of the convolutional kernel parameters are based on synaptic connectivity between the specified neuron and each of a plurality of other neurons in the brain of the biological organism; and
generating the network output based on the layer output of the convolutional neural network layer.

Embodiment 2 is the method of embodiment 1, wherein:

each convolutional kernel parameter corresponds to a respective other neuron in the brain of the biological organism, and

for each other neuron that is connected to the specified neuron by a synaptic connection, the value of the corresponding convolutional kernel parameter is based on a proximity of the other neuron to the specified neuron in the brain of the biological organism.

Embodiment 3 is the method of embodiment 2, wherein determining the values for the plurality of convolutional kernel parameters comprises:

obtaining a synaptic resolution image of at least a portion of the brain of the biological organism; and

processing the image to identify i) the specified neuron, ii) the plurality of other neurons, and iii) the synaptic connections between the specified neuron and the plurality of other neurons.

Embodiment 4 is the method of embodiment 3, wherein:

determining the values for the plurality of convolutional kernel parameters further comprises processing the image to identify a respective direction of the synaptic connections between the specified neuron and the plurality of other neurons; and

for each other neuron, determining the value for the convolutional kernel parameter corresponding to the other neuron using an identified synaptic connection that is directed from the specified neuron to the other neuron.

Embodiment 5 is the method of any one of embodiments 1-4, wherein the convolutional kernel is either one-dimensional or two-dimensional.

Embodiment 6 is the method of any one of embodiments 1-5, wherein the neural network is a recurrent neural network that is configured to obtain a respective network input at each of a plurality of time steps.

Embodiment 7 is the method of embodiment 6, wherein, at each of the plurality of time steps, the convolutional neural network layer processes the layer input for the time step using a different convolutional kernel.

Embodiment 8 is the method of embodiment 7, wherein the respective convolutional kernel for each time step corresponds to a different neuron in the brain of the biological organism.

Embodiment 9 is the method of embodiment 8, wherein:

the convolutional kernel for a first time step of the plurality of time steps corresponds to a first neuron in the brain of the biological organism; and

the convolutional kernel for a subsequent time step of the plurality of time steps corresponds to a second neuron in the brain of the biological organism, wherein the second neuron shares a synaptic connection with the first neuron in the brain of the biological organism.

Embodiment 10 is the method of embodiment 8, wherein:

the convolutional kernel for a first time step of the plurality of time steps corresponds to a first neuron in the brain of the biological organism; and

the convolutional kernel for a subsequent time step of the plurality of time steps corresponds to a second neuron in the brain of the biological organism, wherein the second neuron is closer to a center of the brain than the first neuron.

Embodiment 11 is the method of any one of embodiments 1-10, wherein the network input represents audio data.

Embodiment 12 is the method of embodiment 11, wherein the specified neuron is in an auditory region of the brain of the biological organism.

Embodiment 13 is the method of any one of embodiments 1-12, wherein the neural network further comprises a trained subnetwork, and wherein the neural network has been trained by:

determining initial values for a plurality of trained network parameters of the trained subnetwork;

generating values for the plurality of convolutional kernel parameters;

obtaining a plurality of training examples; and

processing the plurality of training examples using the neural network according to i) the initial values for the plurality of trained network parameters and ii) the values for the convolutional kernel to update the initial values for the plurality of trained network parameters.

Embodiment 14 is the method of embodiment 13, wherein the values for the plurality of convolutional kernel parameters are unchanged during training of the neural network.

Embodiment 15 is the method of any one of embodiments 1-14, wherein:

the convolutional kernel parameters have been determined using a synaptic connectivity graph comprising a plurality of nodes and edges, wherein each edge connects a pair of nodes; and

the synaptic connectivity graph was generated by:
determining a plurality of neurons in the brain of the biological organism and a plurality of synaptic connections between pairs of neurons in the brain of the biological organism;
mapping each neuron in the brain of the biological organism to a respective node in the synaptic connectivity graph; and
mapping each synaptic connection between a pair of neurons in the brain to an edge between a corresponding pair of nodes in the synaptic connectivity graph.

Embodiment 16 is a system comprising: one or more computers and one or more storage devices storing instructions that are operable, when executed by the one or more computers, to cause the one or more computers to perform the method of any one of embodiments 1 to 15.

Embodiment 17 is one or more non-transitory computer storage media encoded with a computer program, the program comprising instructions that are operable, when executed by data processing apparatus, to cause the data processing apparatus to perform the method of any one of embodiments 1 to 15.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain some cases, multitasking and parallel processing may be advantageous.

What is claimed is:

1. A method comprising:
obtaining a network input; and
processing the network input using a neural network to generate a network output, wherein the neural network comprises a convolutional neural network layer and is configured to perform operations comprising:
generating a layer input to the convolutional neural network layer based on the network input;
generating a layer output of the convolutional neural network layer based on the layer input, comprising applying a convolutional kernel having a plurality of convolutional kernel parameters to the layer input,
wherein the convolutional kernel corresponds to a specified neuron in a brain of a biological organism and values of the convolutional kernel parameters are based on synaptic connectivity between the specified neuron and each of a plurality of other neurons in the brain of the biological organism; and
generating the network output based on the layer output of the convolutional neural network layer.

2. The method of claim 1, wherein:
each convolutional kernel parameter corresponds to a respective other neuron in the brain of the biological organism, and
for each other neuron that is connected to the specified neuron by a synaptic connection, the value of the corresponding convolutional kernel parameter is based on a proximity of the other neuron to the specified neuron in the brain of the biological organism.

3. The method of claim 2, wherein determining the values for the plurality of convolutional kernel parameters comprises:
obtaining a synaptic resolution image of at least a portion of the brain of the biological organism; and
processing the image to identify i) the specified neuron, ii) the plurality of other neurons, and iii) the synaptic connections between the specified neuron and the plurality of other neurons.

4. The method of claim 3, wherein:
determining the values for the plurality of convolutional kernel parameters further comprises processing the image to identify a respective direction of the synaptic connections between the specified neuron and the plurality of other neurons; and
for each other neuron, determining the value for the convolutional kernel parameter corresponding to the other neuron using an identified synaptic connection that is directed from the specified neuron to the other neuron.

5. The method of claim 1, wherein the convolutional kernel is either one-dimensional or two-dimensional.

6. The method of claim 1, wherein the neural network is a recurrent neural network that is configured to obtain a respective network input at each of a plurality of time steps.

7. The method of claim 6, wherein, at each of the plurality of time steps, the convolutional neural network layer processes the layer input for the time step using a different convolutional kernel.

8. The method of claim 7, wherein the respective convolutional kernel for each time step corresponds to a different neuron in the brain of the biological organism.

9. The method of claim 8, wherein:
the convolutional kernel for a first time step of the plurality of time steps corresponds to a first neuron in the brain of the biological organism; and
the convolutional kernel for a subsequent time step of the plurality of time steps corresponds to a second neuron in the brain of the biological organism, wherein the second neuron shares a synaptic connection with the first neuron in the brain of the biological organism.

10. The method of claim 8, wherein:
the convolutional kernel for a first time step of the plurality of time steps corresponds to a first neuron in the brain of the biological organism; and
the convolutional kernel for a subsequent time step of the plurality of time steps corresponds to a second neuron in the brain of the biological organism, wherein the second neuron is closer to a center of the brain than the first neuron.

11. The method of claim 1, wherein the network input represents audio data.

12. The method of claim 11, wherein the specified neuron is in an auditory region of the brain of the biological organism.

13. The method of claim 1, wherein the neural network further comprises a trained subnetwork, and wherein the neural network has been trained by:
determining initial values for a plurality of trained network parameters of the trained subnetwork;
generating values for the plurality of convolutional kernel parameters;
obtaining a plurality of training examples; and
processing the plurality of training examples using the neural network according to i) the initial values for the plurality of trained network parameters and ii) the values for the convolutional kernel to update the initial values for the plurality of trained network parameters.

14. The method of claim 13, wherein the values for the plurality of convolutional kernel parameters are unchanged during training of the neural network.

15. The method of claim 1, wherein:
the convolutional kernel parameters have been determined using a synaptic connectivity graph comprising a plurality of nodes and edges, wherein each edge connects a pair of nodes; and
the synaptic connectivity graph was generated by:
determining a plurality of neurons in the brain of the biological organism and a plurality of synaptic connections between pairs of neurons in the brain of the biological organism;
mapping each neuron in the brain of the biological organism to a respective node in the synaptic connectivity graph; and
mapping each synaptic connection between a pair of neurons in the brain to an edge between a corresponding pair of nodes in the synaptic connectivity graph.

16. A system comprising one or more computers and one or more storage devices storing instructions that are operable, when executed by the one or more computers, to cause the one or more computers to perform operations comprising:
obtaining a network input; and
processing the network input using a neural network to generate a network output, wherein the neural network comprises a convolutional neural network layer and is configured to perform operations comprising:
generating a layer input to the convolutional neural network layer based on the network input;
generating a layer output of the convolutional neural network layer based on the layer input, comprising applying a convolutional kernel having a plurality of convolutional kernel parameters to the layer input,
wherein the convolutional kernel corresponds to a specified neuron in a brain of a biological organism and values of the convolutional kernel parameters are based on synaptic connectivity between the specified neuron and each of a plurality of other neurons in the brain of the biological organism; and
generating the network output based on the layer output of the convolutional neural network layer.

17. The system of claim 16, wherein:
each convolutional kernel parameter corresponds to a respective other neuron in the brain of the biological organism, and
for each other neuron that is connected to the specified neuron by a synaptic connection, the value of the corresponding convolutional kernel parameter is based on a proximity of the other neuron to the specified neuron in the brain of the biological organism.

18. The system of claim 16, wherein the neural network further comprises a trained subnetwork, and wherein the neural network has been trained by:
determining initial values for a plurality of trained network parameters of the trained subnetwork;
generating values for the plurality of convolutional kernel parameters;
obtaining a plurality of training examples; and
processing the plurality of training examples using the neural network according to i) the initial values for the plurality of trained network parameters and ii) the values for the convolutional kernel to update the initial values for the plurality of trained network parameters.

19. One or more non-transitory storage media storing instructions that when executed by one or more computers cause the one or more computers to perform operations comprising:
obtaining a network input; and
processing the network input using a neural network to generate a network output, wherein the neural network comprises a convolutional neural network layer and is configured to perform operations comprising:
generating a layer input to the convolutional neural network layer based on the network input;
generating a layer output of the convolutional neural network layer based on the layer input, comprising applying a convolutional kernel having a plurality of convolutional kernel parameters to the layer input,
wherein the convolutional kernel corresponds to a specified neuron in a brain of a biological organism and values of the convolutional kernel parameters are based on synaptic connectivity between the specified neuron and each of a plurality of other neurons in the brain of the biological organism; and
generating the network output based on the layer output of the convolutional neural network layer.

20. The non-transitory storage media of claim 19, wherein:
each convolutional kernel parameter corresponds to a respective other neuron in the brain of the biological organism, and
for each other neuron that is connected to the specified neuron by a synaptic connection, the value of the corresponding convolutional kernel parameter is based on a proximity of the other neuron to the specified neuron in the brain of the biological organism.
